(19) United States
(12) Patent Application Publication
(10) Pub. No.: US 2022/0099461 A1
(43) Pub. Date: Mar. 31, 2022

(54) SAMPLE INTRODUCTION DEVICES AND SYSTEMS AND METHODS OF USING AND PRODUCING THEM

(71) Applicant: Benjamin J. Black, West Valley City, UT (US)

(72) Inventor: Benjamin J. Black, West Valley City, UT (US)

(21) Appl. No.: 17/038,850

(22) Filed: Sep. 30, 2020

(51) Int. Cl. G01D 5/14

(52) U.S. Cl. CPC G01D 5/147

(57) ABSTRACT

Magnetic couplers and sample introduction devices including them are described. In certain configurations, a sample introduction device can include a magnetic coupler that can be used to hold down a sampling device to permit introduction of an analyte sample from the sampling device to an instrument or another component. Systems including the magnetic couplers, and methods and devices to produce them are also described.

### TECHNOLOGICAL FIELD

Certain configurations are directed to sample introduction devices that can be used to hold a sampling device to another component such as an analytical instrument. Methods of using and producing sample introduction devices are also described.

### BACKGROUND

Sample introduction devices are used to introduce a sample into an instrument. Depending on the particular components of the instrument, limitations can exist that prevent use of certain types of sample introduction devices.

### SUMMARY

In an aspect, a sample introduction device comprises an aperture and a first magnetic coupler. In certain embodiments, the aperture can receive a sampling device. In other embodiments, the first magnetic coupler comprises a first housing that comprises a first surface and a second surface opposite the first surface. In certain configurations, the first magnetic coupler comprises a plurality of arranged, individual permanent magnets in the first housing, wherein the first magnetic coupler is configured to magnetically couple to the sampling device at the first surface using a first magnetic field at the first surface, and wherein a magnitude of a second magnetic field at the second surface of the first magnetic coupler is less than a magnitude of the first magnetic field.

In certain examples, the sample introduction device can include a magnetic sensor configured to determine when the sampling device is coupled to the sample introduction device. In some embodiments, the magnetic sensor is configured to determine when a needle trap is inserted into an injector. In other embodiments, the magnetic sensor is configured to determine when a solid-phase microextraction fiber is inserted into an injector. In some embodiments, the magnetic sensor is configured to determine when a microextraction coil is inserted into an injector.

In certain configurations, the first magnetic coupler comprises at least four arranged, individual permanent magnets with pole orientations of adjacent arranged, individual magnets being offset 90 degrees from each other. In other configurations, the first magnetic coupler comprises at least six arranged, individual permanent magnets with pole orientations of adjacent arranged, individual magnets being offset 90 degrees from each other.

In other embodiments, a second magnetic coupler comprising a second housing comprising a third surface, a fourth surface, and a plurality of arranged, individual permanent magnets in the second housing can be present. In some embodiments, the aperture is located between the first magnetic coupler and the second magnetic coupler.

In other embodiments, the magnetic sensor comprises a Hall effect sensor, and wherein the first housing is configured as a square metal tube.

In certain configurations, the first magnetic coupler comprises a Halbach array. In some examples, the first housing comprises a non-ferrous material.

In another aspect, a method comprises inserting a sampling device into an aperture of an instrument to provide a sample from the sampling device to the instrument, wherein the instrument is configured to use an adjacent field to analyze the sample, wherein the sampling device is present in a sample introduction device comprising a first magnetic coupler. For example, the first magnetic coupler may comprise a first housing that comprises a first surface and a second surface opposite the first surface, wherein the first magnetic coupler comprises a plurality of arranged, individual permanent magnets in the first housing, wherein the first magnetic coupler is configured to magnetically couple to the sampling device at the first surface using a first magnetic field at the first surface, and wherein a magnitude of a second magnetic field at the second surface of the first magnetic coupler is less than a magnitude of the first magnetic field.

In certain embodiments, the method comprises detecting a presence of the sampling device using a magnetic sensor. In certain embodiments, inserting the sampling device into the aperture is performed by a human and the magnitude of the first magnetic field is sufficient to hold the sampling device in place without the human touching the sampling device. In some embodiments, the first magnetic coupler holds the sampling device to the aperture without application of any external mechanical force. In other embodiments, the first magnetic coupler holds the sampling device to the aperture without the use of any external fasteners.

In certain configurations, the method comprises detecting the presence of the sampling device without using any magnetic shielding materials between the first magnetic coupler and the adjacent field. In other embodiments, the method comprises configuring the magnetic sensor as a Hall effect sensor.

In certain embodiments, the method comprises configuring the first magnetic coupler with at least four arranged, individual permanent magnets with pole orientations of adjacent arranged, individual magnets being offset 90 degrees from each other. In other embodiments, the method comprises configuring the first magnetic coupler with at least six arranged, individual permanent magnets with pole orientations of adjacent arranged, individual magnets being offset 90 degrees from each other.

In additional embodiments, the method comprises using a second magnetic coupler to magnetically couple to the sampling device, wherein the second magnetic coupler comprises a plurality of arranged, individual permanent magnets in a second housing. In some embodiments, the first magnetic coupler and the second magnetic coupler comprise a different arrangement of individual permanent magnets. In other embodiments, the first housing comprises a square metal tube. In certain embodiments, the first housing comprises a round metal tube.

In some configurations, the method comprises detecting the presence of one or more of a needle trap, a solid-phase microextraction fiber, and a microextraction coil to determine when the sampling device is coupled to the instrument.

In an additional aspect, an instrument comprises a chromatograph, an ionization source, amass spectrometer and a first magnetic coupler. In some configurations, the chromatograph is configured to receive a sample from a sampling device comprising one or more analytes. In some embodiments, the ionization source is configured to receive analyte separated by the chromatograph and ionize the received, separated analyte. In certain embodiments, the mass spectrometer is fluidically coupled to the ionization source and configured to receive the ionized analyte from the ionization source, wherein the mass spectrometer is configured to use a field to filter, select or guide the ionized analyte. In certain configurations, the first magnetic coupler comprises a first housing that comprises a first surface and a second surface opposite the first surface, wherein the first magnetic coupler comprises a plurality of arranged, individual permanent magnets in the first housing, wherein the first magnetic coupler is configured to magnetically couple to the sampling device at the first surface using a first magnetic field at the first surface, and wherein a magnitude of a second magnetic field at the second surface of the first magnetic coupler is less than a magnitude of the first magnetic field.

In certain embodiments, the magnitude of the second magnetic field does not affect the field used by the mass spectrometer to filter, select or guide the ionized analyte. In other embodiments, the chromatograph is a gas chromatograph or a liquid chromatograph. In some embodiments, a magnetic sensor configured to determine when the sampling device is coupled to the instrument is present. In certain configurations, the magnetic sensor is configured to determine when a needle trap is inserted into an injector of the instrument. In other embodiments, the magnetic sensor is configured to determine when a solid-phase microextraction fiber is inserted into an injector of the instrument. In some embodiments, the magnetic sensor is configured to determine when a microextraction coil is inserted into an injector of the instrument. In certain configurations, the first magnetic coupler comprises at least four arranged, individual permanent magnets with pole orientations of adjacent arranged, individual magnets being offset 90 degrees from each other. In other embodiments, the first magnetic coupler comprises at least six arranged, individual permanent magnets with pole orientations of adjacent arranged, individual magnets being offset 90 degrees from each other.

In additional embodiments, the instrument comprises a second magnetic coupler comprising a second housing comprising a third surface, a fourth surface, and a plurality of arranged, individual permanent magnets in the second housing. In some configurations, an aperture is located between the first magnetic coupler and the second magnetic coupler. In certain embodiments, the magnetic sensor comprises a Hall effect sensor, and wherein the first housing is configured as a square metal tube. In some configurations, the first magnetic coupler comprises a Halbach array. In other embodiments, the first housing comprises a non-ferrous material.

In certain embodiments, the ionization source comprises at least one of an inductively coupled plasma, a discharge plasma, a capacitively coupled plasma, a microwave induced plasma, a glow discharge ionization source, a desorption ionization source, an electrospray ionization source, an atmospheric pressure ionization source, atmospheric pressure chemical ionization source, a photoionization source, an electron ionization source, or a chemical ionization source.

In other embodiments, the chromatograph is a gas chromatograph and the mass spectrometer comprises an ion trap. In certain configurations, no magnetic shielding material is present between the first magnetic coupler and the ion trap.

In another aspect, a sample introduction device configured to fluidically couple a sampling device to an instrument is provided. In certain embodiments, the sample introduction device comprises at least one Halbach array configured to hold the sampling device in place while a sample is introduced from the sampling device into the instrument, wherein the Halbach array comprises a plurality of arranged, individual permanent magnets in a housing.

In an additional aspect, an instrument comprises a sample introduction device as described herein, and a sample analyzer comprising at least one magnetic field source configured to generate an analyzing magnetic field to analyze a sample provided from the sampling device to the instrument. For example, the at least one Halbach array of the sample introduction device can be configured to perturb the analyzing magnetic field by less than an amount that would alter analysis of the sample using the analyzing magnetic field.

In another aspect, an assembly fixture to provide a magnetic coupler comprising a plurality of arranged, individual permanent magnets is described. In certain configurations, the assembly fixture is configured to successively receive and insert individual permanent magnets into a housing of the magnetic coupler, wherein the assembly fixture comprises a magnet rotator assembly configured to arrange and offset pole orientations of the successively inserted individual magnets by ninety degrees prior to insertion of the successively inserted individual magnets into the housing of the magnetic coupler. In some embodiments, the plurality of inserted, arranged, individual permanent magnets together function as the magnetic coupler. For example, the magnetic coupler comprises a first surface and a second surface opposite the first surface, wherein the magnetic coupler comprises a first magnetic field at the first surface, and wherein a magnitude of a second magnetic field at the second surface of the magnetic coupler is less than a magnitude of the first magnetic field.

In certain embodiments, the magnet rotator assembly comprises a first position, a second position, a third position and a fourth position. In other embodiments, the assembly fixture comprises a slot configured to receive the housing of the magnetic coupler. In some embodiments, the slot is sized and arranged to receive an insert that retains the housing of the magnetic coupler in the assembly fixture.

In other embodiments, the magnet rotator assembly comprises a magnet loading station configured to receive an individual permanent magnet, wherein the first position, the second position, the third position and the fourth position of the magnet rotator assembly orient poles of the individual magnets in different pole orientations.

In certain configurations, the assembly fixture comprises an insertion device configured to engage a loaded, individual magnet in the magnetic loading station and provide a force to place the loaded, individual magnet into the housing of the magnetic coupler. In some embodiments, depression of the insertion device to place the loaded, individual magnet into the housing of the magnetic coupler contacts the magnet rotator assembly to rotate the magnet rotator assembly to a different position. In other embodiments, retraction of the insertion device after placement of the loaded, individual magnet into the housing of the magnetic coupler contacts the magnet rotator assembly to rotate the magnet rotator assembly to a different position. In certain embodiments, the slot is sized and arranged to receive the housing, and wherein the housing is sized and arranged to receive at least four individual permanent magnets. In other embodiments, the slot is sized and arranged to receive the housing, and wherein the housing is sized and arranged to receive at least six individual permanent magnets.

In another aspect, an assembly fixture to provide a magnetic coupler is described. In certain configurations, the assembly fixture comprises a magnet loading station sized and arranged to receive an individual permanent magnet. In other embodiments, the assembly fixture comprises a magnet rotator assembly magnetically coupled to the magnet loading station, wherein the magnet rotator assembly comprises a first position, a second position, a third position and a fourth position. In some configurations, the assembly fixture comprises a first end configured to receive and position a housing of the magnetic coupler, wherein the housing of the magnetic coupler is configured to successively receive a plurality of individually arranged permanent magnets and retain the received, plurality of individually arranged permanent magnets in the housing of the magnetic coupler. In other embodiments, the assembly fixture comprises an insertion device configured to provide a force to insert an individual permanent magnet in the magnet loading station into the housing of the magnetic coupler.

In certain embodiments, the first position of the magnet rotator assembly permits loading of a first individual permanent magnet into the magnet loading station at a first pole orientation. For example, insertion of the loaded, first individual permanent magnet, using the insertion device, into the housing of the magnetic coupler rotates the magnet rotator assembly from the first position to the second position. In other embodiments, the second position of the magnet rotator assembly permits loading of a second individual permanent magnet into the magnet loading station at a second pole orientation rotated ninety degrees from the first pole orientation. For example, insertion of the loaded, second individual permanent magnet, using the insertion device, into the housing of the magnetic coupler rotates the magnet rotator assembly from the second position to the third position. In additional embodiments, the third position of the magnet rotator assembly permits loading of a third individual permanent magnet into the magnet loading station at a third pole orientation rotated ninety degrees from the second pole orientation. For example, insertion of the loaded, third individual permanent magnet, using the insertion device, into the housing of the magnetic coupler rotates the magnet rotator assembly from the third position to the fourth position. In some embodiments, the fourth position of the magnet rotator assembly permits loading of a fourth individual permanent magnet into the magnet loading station at a fourth pole orientation rotated ninety degrees from the third pole orientation. In certain examples, insertion of the loaded, fourth individual permanent magnet, using the insertion device, into the housing of the magnetic coupler rotates the magnet rotator assembly from the fourth position to the first position and provides a magnetic coupler comprising a first surface and a second surface opposite the first surface. In certain embodiments, the magnetic coupler comprises a first magnetic field at the first surface, and wherein a magnitude of a second magnetic field at the second surface of the magnetic coupler is less than a magnitude of the first magnetic field.

In some configurations, after insertion of the fourth individual permanent magnet, the first position permits loading of a fifth individual permanent magnet into the magnet loading station, wherein insertion of the loaded, fifth individual permanent magnet into the housing of the magnetic coupler aligns a pole orientation of the inserted fifth individual permanent magnet with the first pole orientation. In other configurations, after insertion of the fifth individual permanent magnet, the second position permits loading of a sixth individual permanent magnet into the magnet loading station, wherein insertion of the loaded, sixth individual permanent magnet into the housing of the magnetic coupler aligns a pole orientation of the inserted sixth individual permanent magnet with the second pole orientation.

In certain embodiments, the first end comprises a slot sized and arranged to receive the housing of the magnetic coupler. In other embodiments, the slot comprises a square or rectangular geometry.

In an additional aspect, a method of producing a magnetic coupler comprises successively placing a plurality of individual permanent magnets into a housing of the magnetic coupler by loading a first individual permanent magnet into a magnet loading station at a first position of a magnet rotator assembly, and installing the loaded, first individual permanent magnet into the housing, wherein installing the loaded first individual permanent magnet into the housing rotates the magnet rotator assembly to a second position. In some embodiments, the method comprises loading a second individual permanent magnet into the magnet loading station at the second position of the magnet rotator assembly, wherein the second position loads the second individual permanent magnet into the magnet loading station so a pole orientation of the loaded, second individual permanent magnet is ninety degrees from a pole orientation of the loaded, first individual permanent magnet, and installing the loaded, second individual permanent magnet into the housing, wherein installing the loaded second individual permanent magnet into the housing rotates the magnet rotator assembly to a third position. In certain embodiments, the method comprises loading a third individual permanent magnet into the magnet loading station at the third position of the magnet rotator assembly, wherein the third position loads the third individual permanent magnet into the magnet loading station so a pole orientation of the loaded, third individual permanent magnet is ninety degrees from a pole orientation of the loaded, second individual permanent magnet, and installing the loaded, third individual permanent magnet into the housing, wherein installing the loaded, third individual permanent magnet into the housing rotates the magnet rotator assembly to a fourth position. In some embodiments, the method comprises loading a fourth individual permanent magnet into the magnet loading station at the fourth position of the magnet rotator assembly, wherein the fourth position loads the fourth individual permanent magnet into the magnet loading station so a pole orientation of the loaded, fourth individual permanent magnet is ninety degrees from a pole orientation of the loaded, third individual permanent magnet, and installing the loaded, fourth individual permanent magnet into the housing, wherein installing the loaded, fourth individual permanent magnet into the housing rotates the magnet rotator assembly to the first position, and wherein the produced magnetic coupler comprises a first magnetic field at a first surface of the housing and substantially no magnetic field at a second, opposite surface of the housing.

In certain embodiments, the method comprises, after installing the loaded, fourth individual permanent magnet, loading a fifth individual permanent magnet into the magnet loading station at the first position of the magnet rotator assembly, wherein the first position loads the fifth individual permanent magnet into the magnet loading station so a pole orientation of the loaded, fifth individual permanent magnet is ninety degrees from a pole orientation of the loaded, fourth individual permanent magnet, and installing the loaded, fifth individual permanent magnet into the housing, wherein installing the loaded, fifth individual permanent magnet into the housing rotates the magnet rotator assembly to the second position.

In other embodiments, the method comprises, after installing the loaded, fifth individual permanent magnet, loading a sixth individual permanent magnet into the magnet loading station at the second position of the magnet rotator assembly, wherein the second position loads the sixth individual permanent magnet into the magnet loading station so a pole orientation of the loaded, sixth individual permanent magnet is ninety degrees from a pole orientation of the loaded, fifth individual magnet, and installing the loaded, sixth individual permanent magnet into the housing, wherein installing the loaded, sixth individual permanent magnet into the housing rotates the magnet rotator assembly to the third position.

In some configurations, the method comprises sealing ends of the housing to retain the installed, individual first, second, third and fourth permanent magnets in the housing. In other configurations, the method comprises crimping ends of the housing to retain the installed, individual first, second, third and fourth permanent magnets in the housing. In additional examples, the method comprises applying an adhesive to at least one end of the housing to retain the installed, individual first, second, third and fourth permanent magnets in the housing.

In another aspect, a method of producing a Halbach array configured to hold a sampling device in place while a sample is introduced from the sampling device into an instrument comprises using an assembly fixture to successively install individual permanent magnets into a housing to provide the Halbach array, wherein the assembly fixture is configured to position and load adjacent magnets in the housing so magnetic poles of adjacent, loaded magnets are offset by ninety degrees.

In an additional aspect, a test fixture for testing a magnetic coupler comprises a housing containing a plurality of individually arranged permanent magnets, the test fixture comprising a base configured to receive the magnetic coupler in a slidable tray of the base, wherein the magnetic coupler comprises a first magnetic field at a first surface of the housing and a second magnetic field at a second, opposite surface of the housing, wherein a magnitude of the second magnetic field is less than a magnitude the first magnetic field. In some embodiments, the test fixture comprises an aperture in the base to measure a magnetic field below the second, opposite surface of the received magnetic coupler in the slidable tray, wherein the slidable tray is configured to slide from one side of the base to another side of the base to alter a position of the received magnetic coupler, with respect to a position of the aperture in the base, to measure magnetic field strength along the second, opposite surface of the magnetic coupler.

Additional aspects, embodiments, configurations and features are described in more detail below

### BRIEF DESCRIPTION OF THE SEVERAL VIEWS OF THE DRAWINGS

Certain aspects, embodiments, configurations, and features are described with reference to the accompanying figures in which:

FIG. 1 is an illustration showing a sample introduction device coupled to an instrument, in accordance with some examples;

FIG. 2 is an illustration showing a sample introduction device comprising a magnetic coupler, in accordance with some embodiments;

FIG. 3 is an illustration showing a sample introduction device comprising two magnetic couplers, in accordance with certain embodiments;

FIG. 4 is an illustration showing a sample introduction device comprising three magnetic couplers, in accordance with some embodiments;

FIG. 5 is an illustration showing a sample introduction device comprising four magnetic couplers, in accordance with certain embodiments;

FIG. 6 is an illustration showing two magnetic couplers on the same side of an aperture, in accordance with some examples;

FIG. 7 is an illustration showing a magnetic coupler array, in accordance with some embodiments;

FIG. 8 is an illustration showing a needle trap, in accordance with some embodiments;

FIG. 9 is an illustration showing a sorbent tube, in accordance with certain examples;

FIG. 10A is an illustration showing a solid phase microextraction fiber, in accordance with some embodiments;

FIG. 10B is an illustration showing a microextraction coil, in accordance with some embodiments;

FIG. 11 is an illustration showing a gas chromatography system, in accordance with certain embodiments;

FIG. 12 is an illustration showing a liquid chromatography system, in accordance with some embodiments;

FIG. 13 is an illustration showing a supercritical fluid chromatography system, in accordance with certain embodiments;

FIG. 14 is an illustration of a system comprising an ionization source and a mass analyzer, in accordance with some embodiments;

FIGS. 15A and 15B are illustration showing magnetic couplers and a needle extractor inserted into an aperture of a sample introduction device, in accordance with some embodiments;

FIG. 16 is a cross-section showing a sample introduction device and a transfer line, in accordance with some embodiments;

FIG. 17 is a top view of the device of FIG. 16 showing two magnetic couplers and an aperture in a sample introduction device, in accordance with certain embodiments;

FIG. 18 is a perspective view of an assembly fixture to assembly a magnetic coupler, in accordance with some embodiments;

FIG. 19 is a side view of an assembly fixture to assembly a magnetic coupler, in accordance with some embodiments;

FIG. 20A is a perspective view of a magnetic coupler, and FIG. 20B is a view of the magnetic coupler showing an arrangement of magnets within a housing of the magnetic coupler, in accordance with some embodiments; and

FIG. 21 is an illustration of a text fixture that can be used to measure a magnetic field strength of the magnetic coupler.

### DETAILED DESCRIPTION

While certain configurations, embodiments and features are described in connection with sampling devices, sample introduction devices, magnetic couplers, instruments and other devices, the described configurations, embodiments and features are intended to be merely illustrative of some of the many different configurations, embodiments and features that may be included in the sampling devices, sample introduction devices, magnetic couplers, instruments and other devices. Additional configurations, embodiments and features will be recognized by the person having ordinary skill in the art, given the benefit of this description. The size of one component relative to another component may be exaggerated, distorted or otherwise not drawn to scale in the figures to facilitate a more user-friendly description of the technology described herein. No particular dimensions, sizes, shapes, geometries or other arrangements are intended to be required unless made clear from the description of that particular embodiment.

Certain configurations and embodiments described herein use a magnetic coupler to hold a first component to a second component. While the exact components which are held together may vary, a magnetic field (provided by one or both of the first and second components) does not adversely affect the field used by an instrument or device. For example, a magnetic field of the first component or the second component does not affect a field used by a mass spectrometer to filter, select or guide the ionized analyte. As noted in more detail below, by configuring the magnetic field with a suitable orientation, the magnetic coupler can hold components together without adversely affecting or altering a field used by another component or system of an instrument. This arrangement permits rapid coupling and decoupling of items to the instrument without the need to use any external fasteners, fittings, etc., though such fasteners, fittings, etc. could also be used if desired.

Other configurations and embodiments described herein are directed to a device that can be used to provide a magnetic coupler comprising multiple individual magnets. By using multiple individual magnets, e.g., four or more individual magnets, a magnetic coupler can be produced that is inexpensive and easy to produce. Further, the exact number of magnets used can be varied from four, six, eight or more individual magnets as desired. The individual magnets can be packaged and held in a housing to provide the magnetic coupler. The overall magnetic field strength (and magnetic field pattern) can also be altered by selection of individual magnets.

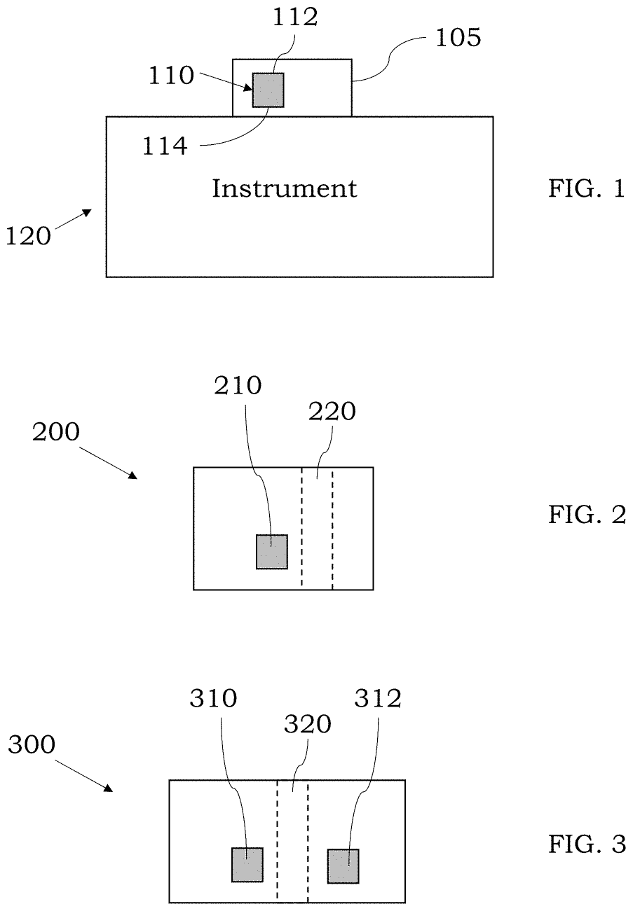

In certain embodiments, a sample introduction device may comprise or be configured as, or with, a first magnetic coupler. Referring to FIG. 1, a sample introduction device 105 comprising a magnetic coupler 110 is shown that comprises a first surface 112 and a second surface 114. The magnetic coupler 110 can be used to fluidically couple or hold a sampling device (not shown) to an instrument 120, or a component thereof, so analyte sample in the sampling device may be provided from the sampling device to the instrument 120. As noted in more detail below, a magnetic field strength at the first surface 112 is not necessarily the same as a magnetic field strength at the second surface 114. In some configurations, the strength of the magnetic field at the second surface 114 may be less than the strength of the magnetic field at the first surface 112. In some instances, a magnetic field strength at the second surface 114 may be about zero or close to zero. Depending on the overall orientation of the sample introduction device 105, the strength of the magnetic field at the second surface 114 may be greater than the strength of the magnetic field at the first surface 112. While not needed in all cases, the presence of a lower magnetic field strength at one of the surfaces of the magnetic coupler 110 can reduce the likelihood of disruption or interference with magnetic sensors or another electric or magnetic field used by the instrument. At the same time, the presence of the magnetic field adjacent to at least one of the surfaces of the coupler 110 can act to hold the sampling device to the instrument at an appropriate site to provide analyte sample to the instrument. This configuration may also allow for the omission of magnetic shielding materials to shield any adjacent electric or magnetic field of the instrument from the field(s) of the magnetic coupler. In some instances, the magnetic coupler 110 may be configured as a Halbach array as discussed in more detail below. If desired, the sample introduction device 105 may comprise two, three, four or more magnetic couplers to assist in fluidically coupling the sampling device to another port or component of the instrument 120. In some configurations, the magnetic coupler can be used to fluidically couple the sample introduction device 105 to the instrument 120 without using any external fasteners or without application of any external mechanical force. For example, a user can insert a sampling device into an aperture of the sample introduction device, and the magnetic field from the magnetic coupler can hold the sampling device in place without the need to apply an external force or otherwise hold the sampling device in place. Further, threads or external fasteners can be omitted to facilitate rapid insertion and removal of the sampling devices.

In certain configurations and referring to FIG. 2, a sample introduction device 200 is shown that comprises a first magnetic coupler 210 and a port or aperture 220 configured to receive a sampling device. The exact dimensions and size of the aperture 220 may vary and, if desired, the sampling device could couple to the aperture 220 through a friction fit. In other instances, the magnetic field from the magnetic coupler 210 can be used to hold the sampling device within the aperture 220 and hold the sampling device against a component of an instrument so sample can be transferred from the sampling device to the instrument. For example, a terminal end of the sampling device can be held against or within an injector so sample from the sampling device can be provided into the injector. In some instances, the magnetic coupler 210 may comprise a plurality of arranged, individual permanent magnets in a housing. The magnets can be arranged in the housing so the coupler 210 functions as a Halbach array. For example, the magnetic coupler 210 can be configured to magnetically couple to the sampling device. In some examples, the magnetic coupler 210 comprises at least four arranged, individual permanent magnets with pole orientations of adjacent arranged, individual magnets being offset 90 degrees from each other. In other embodiments, the magnetic coupler 210 comprises at least six arranged, individual permanent magnets with pole orientations of adjacent arranged, individual magnets being offset 90 degrees from each other. The magnets may comprise many different materials including ferrous materials, rare earth materials or other magnetic materials and combinations of magnetic materials. As noted below, other arrangements including, for example, circular Halbach arrays, can be used instead to provide a magnetic coupler. The exact positioning of the magnetic coupler 210 in the sample introduction device 200 can vary and desirably the magnetic coupler 210 is close enough to the sampling device to hold it in place during use of the sample introduction device. For example, a first surface of the magnetic coupler 210 can be placed adjacent to a sampling device in the aperture 220 to provide a magnetic field adjacent to the sampling device and hold it in place in use of the sample introduction device. Other arrangements and positioning of the magnetic coupler 210 with respect to the position of the sampling device will be selected by the person having ordinary skill in the art, given the benefit of this disclosure.

In other configurations and referring to FIG. 3, a sample introduction device 300 is shown comprising a first magnetic coupler 310, a second magnetic coupler 312 and a port or aperture 320 configured to receive a sampling device. The first magnetic coupler 310 and the second magnetic 312 coupler may be the same or may be different. Further, the magnetic couplers 310, 312 can be spaced about the same distance from the aperture 320 or can be spaced different distances from the aperture 320. The exact dimensions and size of the aperture 320 may vary and typically the sampling device couples to the aperture 320 through one or more of a friction fit, a gasket, a rubber seal, and combinations thereof, though threads or other suitable couplings and fittings could also be used if desired. In other instances, the magnetic field from the magnetic couplers 310, 312 can be used to hold the sampling device within the aperture 320 and hold the sampling device against a component of an instrument, e.g., an injector, so sample can be transferred from the sampling device to the instrument. In some instances, each of the magnetic couplers 310, 312 may independently comprise a plurality of arranged, individual permanent magnets in a housing. The magnets can be arranged in the housing so each of the magnetic couplers 310, 312 function as a Halbach array. For example, each of the magnetic couplers 310, 312 can be configured to magnetically couple to the sampling device. In some examples, each of the magnetic couplers 310, 312 comprises at least four arranged, individual permanent magnets with pole orientations of adjacent arranged, individual magnets being offset 90 degrees from each other. In other embodiments, each of the magnetic couplers 310, 312 comprises at least six arranged, individual permanent magnets with pole orientations of adjacent arranged, individual magnets being offset 90 degrees from each other. The magnets may comprise many different materials including ferrous materials, rare earth materials or other magnetic materials and combinations of magnetic materials. If desired, the magnetic coupler 310 may comprise more or fewer permanent magnets than the magnetic coupler 312. As noted below, other arrangements including, for example, circular Halbach arrays, can be used instead to provide the magnetic coupler 310 or 312 or both. In some instances, one of the magnetic couplers 310, 312 may be a linear Halbach array and the other coupler may be a circular Halbach array. The exact positioning of the magnetic couplers 310, 312 in the sample introduction device 300 can vary and desirably the magnetic couplers 310, 312 are close enough to the sampling device to hold it in place during use of the sample introduction device. For example, a first surface of the magnetic coupler 310 can be placed adjacent to a sampling device in the aperture 320 to provide a magnetic field adjacent to the sampling device and hold it in place in use of the sample introduction device. Similarly, a first surface of the magnetic coupler 312 can be placed adjacent to a sampling device in the aperture 320 to provide a magnetic field adjacent to the sampling device and hold it in place in use of the sample introduction device. Other arrangements and positioning of the magnetic couplers 310, 312 with respect to the position of the sampling device will be selected by the person having ordinary skill in the art, given the benefit of this disclosure.

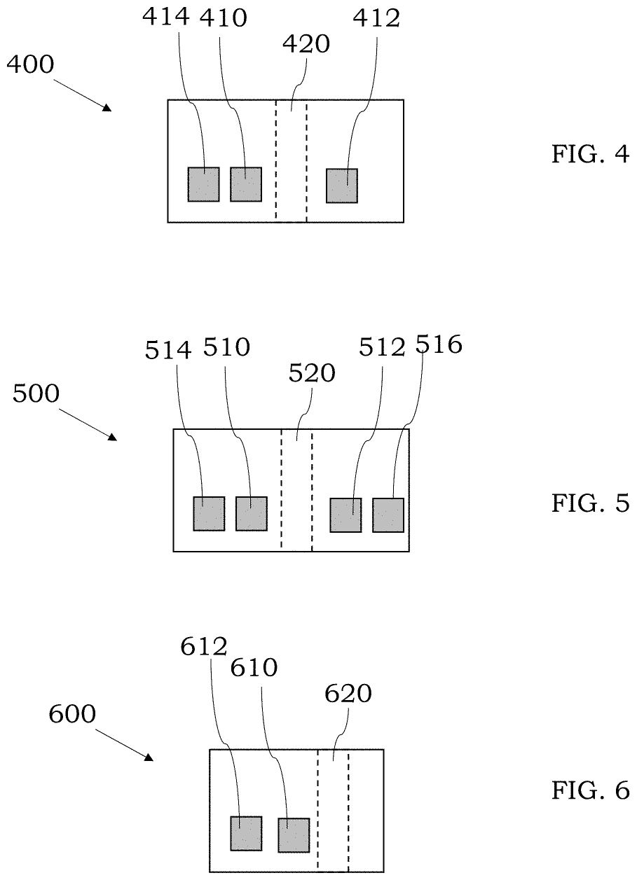

In some embodiments and referring to FIG. 4, a sample introduction device 400 is shown comprising a first magnetic coupler 410, a second magnetic coupler 412, a third magnetic coupler 414 and a port or aperture 420 configured to receive a sampling device. The first magnetic coupler 410, the second magnetic coupler 412 and the third magnetic coupler 414 may be the same or may be different. Further, the magnetic couplers 410, 412 can be spaced about the same distance from the aperture 420 or can be spaced different distances from the aperture 420. The exact dimensions and size of the aperture 420 may vary and typically the sampling device couples to the aperture 420 through one or more of a friction fit, a gasket, a rubber seal and combinations thereof, though threads or other suitable couplings and fittings could also be used if desired. In other instances, the magnetic field from the magnetic couplers 410, 412, 414 can be used to hold the sampling device within the aperture 420 and hold the sampling device against a component of an instrument, e.g., an injector, so sample can be transferred from the sampling device to the instrument. In some instances, each of the magnetic couplers 410, 412, 414 may independently comprise a plurality of arranged, individual permanent magnets in a housing. The magnets can be arranged in the housing so each of the magnetic couplers 410, 412, 414 function as a Halbach array. For example, each of the magnetic couplers 410, 412, 414 can be configured to magnetically couple to the sampling device. In some examples, each of the magnetic couplers 410, 412, 414 comprises at least four arranged, individual permanent magnets with pole orientations of adjacent arranged, individual magnets being offset 90 degrees from each other. In other embodiments, each of the magnetic couplers 410, 412, 414 comprises at least six arranged, individual permanent magnets with pole orientations of adjacent arranged, individual magnets being offset 90 degrees from each other. The magnets may comprise many different materials including ferrous materials, rare earth materials or other magnetic materials and combinations of magnetic materials. If desired, any one of the magnetic couplers 410, 414, 414 may comprise more or fewer permanent magnets than the other magnetic couplers 410, 412, 414. As noted below, other arrangements including, for example, circular Halbach arrays, can be used instead to provide a magnetic coupler. In some instances, one of the magnetic couplers 410, 412, 414 may be a linear Halbach array and the other couplers may be a circular Halbach array. In alternative arrangement, two or more of the couplers 410, 412, 414 may be linear Halbach arrays or two or more of the couplers 410, 412, 414 may be circular Halbach arrays. The exact positioning of the magnetic couplers 410, 412, 414 in the sample introduction device 400 can vary and desirably the magnetic couplers 410, 412, 414 are close enough to the sampling device to hold it in place during use of the sample introduction device. For example, a first surface of the magnetic coupler 410 can be placed adjacent to a sampling device in the aperture 420 to provide a magnetic field adjacent to the sampling device and hold it in place in use of the sample introduction device. Similarly, a first surface of the magnetic coupler 412 can be placed adjacent to a sampling device in the aperture 420 to provide a magnetic field adjacent to the sampling device and hold it in place in use of the sample introduction device. The magnetic coupler 414 can magnetically couple to the sampling device and/or may magnetically couple to the instrument to assist in holding the sample introduction device 400 in place. Other arrangements and positioning of the magnetic couplers 410, 412, 414 with respect to the position of the sampling device will be selected by the person having ordinary skill in the art, given the benefit of this disclosure.

In certain embodiments and referring to FIG. 5, a sample introduction device 500 is shown comprising a first magnetic coupler 510, a second magnetic coupler 512, a third magnetic coupler 514, a fourth magnetic coupler 516 and a port or aperture 520 configured to receive a sampling device. The first magnetic coupler 510, the second magnetic coupler 512, the third magnetic coupler 514 and the fourth magnetic coupler 516 may be the same or may be different. Further, the magnetic couplers 510, 512 can be spaced about the same distance from the aperture 520 or can be spaced different distances from the aperture 520. The magnetic couplers 514, 516 can be spaced about the same distance from the aperture 520 or can be spaced different distances from the aperture 520. The exact dimensions and size of the aperture 520 may vary and typically the sampling device couples to the aperture 520 through a friction fit. In other instances, the magnetic field from the magnetic couplers 510, 512, 514, 516 can be used to hold the sampling device within the aperture 520 and hold the sampling device against a component of an instrument, e.g., an injector, so sample can be transferred from the sampling device to the instrument. If desired, however, the sample could instead be transferred from the instrument to the sampling device depending on the overall configuration of the system. In some instances, each of the magnetic couplers 510, 512, 514, 516 may independently comprise a plurality of arranged, individual permanent magnets in a housing. The magnets can be arranged in the housing so each of the magnetic couplers 510, 512, 514, 516 function as a Halbach array. For example, each of the magnetic couplers 510, 512, 514, 516 can be configured to magnetically couple to the sampling device. In some examples, each of the magnetic couplers 510, 512, 514, 516 comprises at least four arranged, individual permanent magnets with pole orientations of adjacent arranged, individual magnets being offset 90 degrees from each other. In other embodiments, each of the magnetic couplers 510, 512, 514, 516 comprises at least six arranged, individual permanent magnets with pole orientations of adjacent arranged, individual magnets being offset 90 degrees from each other. The magnets may comprise many different materials including ferrous materials, rare earth materials or other magnetic materials and combinations of magnetic materials. If desired, any one of the magnetic couplers 510, 512, 514, 516 may comprise more or fewer permanent magnets than the other magnetic couplers 510, 512, 514, 516. As noted below, other arrangements including, for example, circular Halbach arrays, can be used instead to provide a magnetic coupler. In some instances, one of the magnetic couplers 510, 512, 514, 516 may be a linear Halbach array and the other couplers may be a circular Halbach array. In alternative arrangement, two or more of the couplers 510, 512, 514, 516 may be linear Halbach arrays or two or more of the couplers 510, 512, 514, 516 may be circular Halbach arrays. The exact positioning of the magnetic couplers 510, 512, 514, 516 in the sample introduction device 500 can vary and desirably the magnetic couplers 510, 512, 514, 516 are close enough to the sampling device to hold it in place during use of the sample introduction device. For example, a first surface of the magnetic coupler 510 can be placed adjacent to a sampling device in the aperture 520 to provide a magnetic field adjacent to the sampling device and hold it in place in use of the sample introduction device. Similarly, a first surface of the magnetic coupler 512 can be placed adjacent to a sampling device in the aperture 520 to provide a magnetic field adjacent to the sampling device and hold it in place in use of the sample introduction device. The magnetic couplers 514, 516 can magnetically couple to the sampling device and/or may magnetically couple to the instrument to assist in holding the sample introduction device 500 in place. Other arrangements and positioning of the magnetic couplers 510, 512, 514, 516 with respect to the position of the sampling device will be selected by the person having ordinary skill in the art, given the benefit of this disclosure.

In embodiments comprising two or more magnetic couplers, the magnetic couplers need not be spaced or positioned on each side of the aperture. Referring to FIG. 6, a sample introduction device 600 comprises a first magnetic coupler 610, a second magnetic coupler 612 and an aperture 620. The first magnetic coupler 610 and the second magnetic 612 coupler may be the same or may be different and are positioned on one side of the aperture 620. The exact dimensions and size of the aperture 620 may vary and typically the sampling device couples to the aperture 620 through a friction fit. In other instances, the magnetic field from one or both of the magnetic couplers 610, 612 can be used to hold the sampling device within the aperture 620 and hold the sampling device against a component of an instrument, e.g., an injector, so sample can be transferred from the sampling device to the instrument. If desired, however, the sample could instead be transferred from the instrument to the sampling device depending on the overall configuration of the system. In some instances, each of the magnetic couplers 610, 612 may independently comprise a plurality of arranged, individual permanent magnets in a housing. The magnets can be arranged in the housing so each of the magnetic couplers 610, 612 function as a Halbach array. For example, each of the magnetic couplers 610, 612 can be configured to magnetically couple to the sampling device. In some examples, each of the magnetic couplers 610, 612 comprises at least four arranged, individual permanent magnets with pole orientations of adjacent arranged, individual magnets being offset 90 degrees from each other. In other embodiments, each of the magnetic couplers 610, 612 comprises at least six arranged, individual permanent magnets with pole orientations of adjacent arranged, individual magnets being offset 90 degrees from each other. The magnets may comprise many different materials including ferrous materials, rare earth materials or other magnetic materials and combinations of magnetic materials. If desired, the magnetic coupler 610 may comprise more or fewer permanent magnets than the magnetic coupler 612. Other arrangements including, for example, circular Halbach arrays, can be used instead to provide a magnetic coupler. In some instances, one of the magnetic couplers 610, 612 may be a linear Halbach array and the other coupler may be a circular Halbach array. The exact positioning of the magnetic couplers 610, 612 in the sample introduction device 600 can vary and desirably at least one of the magnetic couplers 610, 612 is close enough to the sampling device to hold it in place during use of the sample introduction device. For example, a first surface of the magnetic coupler 610 can be placed adjacent to a sampling device in the aperture 620 to provide a magnetic field adjacent to the sampling device and hold it in place in use of the sample introduction device. Other arrangements and positioning of the magnetic couplers 610, 612 with respect to the position of the sampling device will be selected by the person having ordinary skill in the art, given the benefit of this disclosure.

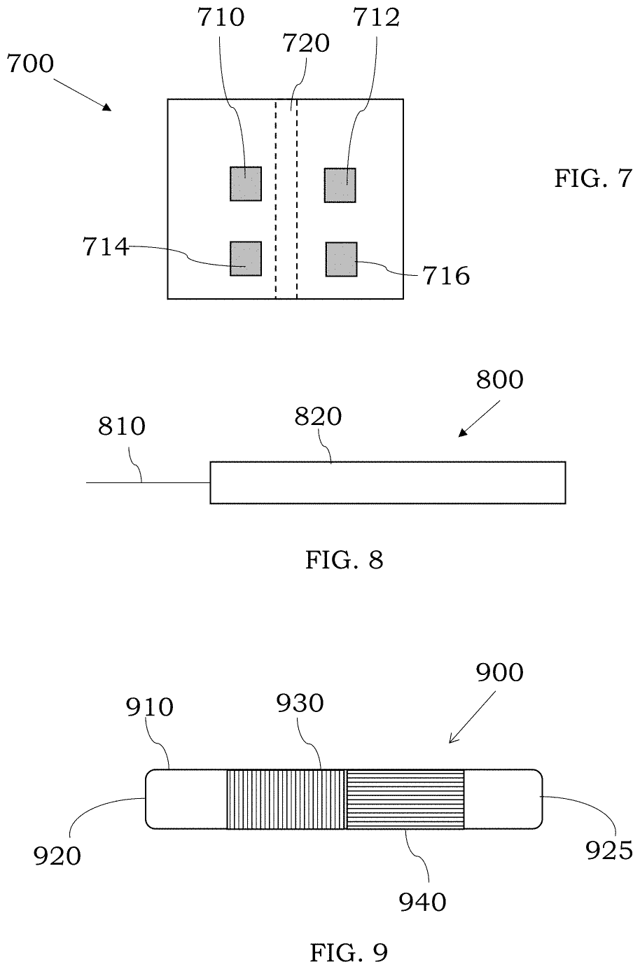

In some embodiments, an array of magnetic couplers may be present in a sample introduction device. For example and referring to FIG. 7, a 2×2 array of magnetic couplers is present with magnetic couplers 710, 712 positioned at a different radial plane along an aperture 720 than a radial plane where magnetic couplers 714, 716 are positioned. Other arrays including 3×3, 4×4, 5×5, 6×6 or asymmetric arrays, e.g., 2×3, 2×4, 3×2, 3×4, etc. may be present instead. The first magnetic coupler 710, the second magnetic coupler 712, the third magnetic coupler 714 and the fourth magnetic coupler 716 may be the same or may be different. Further, the magnetic couplers 710, 712 can be spaced about the same distance from the aperture 720 or can be spaced different distances from the aperture 720. The magnetic couplers 714, 716 can be spaced about the same distance from the aperture 720 or can be spaced different distances from the aperture 720. The exact dimensions and size of the aperture 720 may vary and typically the sampling device couples to the aperture 720 through a friction fit. In other instances, the magnetic field from the magnetic couplers 710, 712, 714, 716 can be used to hold the sampling device within the aperture 720 and hold the sampling device against a component of an instrument, e.g., an injector, so sample can be transferred from the sampling device to the instrument. If desired, however, the sample could instead be transferred from the instrument to the sampling device depending on the overall configuration of the system. In some instances, each of the magnetic couplers 710, 712, 714, 716 may independently comprise a plurality of arranged, individual permanent magnets in a housing. The magnets can be arranged in the housing so each of the magnetic couplers 710, 712, 714, 716 function as a Halbach array. For example, each of the magnetic couplers 710, 712, 714, 716 can be configured to magnetically couple to the sampling device. In some examples, each of the magnetic couplers 710, 712, 714, 716 comprises at least four arranged, individual permanent magnets with pole orientations of adjacent arranged, individual magnets being offset 90 degrees from each other. In other embodiments, each of the magnetic couplers 710, 712, 714, 716 comprises at least six arranged, individual permanent magnets with pole orientations of adjacent arranged, individual magnets being offset 90 degrees from each other. The magnets may comprise many different materials including ferrous materials, rare earth materials or other magnetic materials and combinations of magnetic materials. If desired, any one of the magnetic couplers 710, 712, 714, 716 may comprise more or fewer permanent magnets than the other magnetic couplers 710, 712, 714, 716. Other arrangements including, for example, circular Halbach arrays, can be used instead to provide a magnetic coupler. In some instances, one of the magnetic couplers 710, 712, 714, 716 may be a linear Halbach array and the other couplers may be a circular Halbach array. In alternative arrangement, two or more of the couplers 710, 712, 714, 716 may be linear Halbach arrays or two or more of the couplers 710, 712, 714, 716 may be circular Halbach arrays. The exact positioning of the magnetic couplers 710, 712, 714, 716 in the sample introduction device 700 can vary and desirably the magnetic couplers 710, 712, 714, 716 are close enough to the sampling device to hold it in place during use of the sample introduction device. For example, a first surface of the magnetic coupler 710 can be placed adjacent to a sampling device in the aperture 720 to provide a magnetic field adjacent to the sampling device and hold it in place in use of the sample introduction device. Similarly, a first surface of the magnetic coupler 712 can be placed adjacent to a sampling device in the aperture 720 to provide a magnetic field adjacent to the sampling device and hold it in place in use of the sample introduction device. The magnetic couplers 714, 716 can magnetically couple to the sampling device and/or may magnetically couple to the instrument to assist in holding the sample introduction device 700 in place. Other arrangements and positioning of the magnetic couplers 710, 712, 714, 716 with respect to the position of the sampling device will be selected by the person having ordinary skill in the art, given the benefit of this disclosure.

While sample introduction devices comprising one to four magnetic couplers are shown in FIGS. 1-7, more than four magnetic couplers may be present if desired. Further, certain magnetic couplers may be present to position the sampling device in place within the sample introduction device and other magnetic couplers may be present to hold the sample introduction device to another component of an instrument.

In certain configurations, the sampling devices used with the magnetic couplers described herein may take many forms including needles, needle traps, sorbent tubes, solid phase microextraction (SPME) sampling devices, microextraction coil sampling devices and other sampling devices that can be used to sample a gas, liquid, solid or other materials. In some embodiments, the sampling devices can be used to sample gaseous analyte. For example, gaseous analyte may be drawn into, absorbed by or otherwise introduced into a sampling device where it can be retained and later analyzed by introducing it from the sampling device into an instrument. One or more magnetic couplers can be used to hold the sampling device down and permit introduction from the sampling device into another component of an instrument. In some instances, the sampling device may comprise a magnetic or ferrous material that can act to initiate a sensor present in the instrument. For example, a ferrous material may be present in or on an outside surface of the sampling device. When the sampling device is held down by the magnetic coupler, the presence of the ferrous material can be detected by a magnetic sensor to initiate analysis of the sample in the sampling device. The sampling device may be used to actively or passively sample many different environments. Active sampling can involve pumping of a gaseous sample into or through the sampling device, whereas passive sampling involves retention or adsorption of analyte sample through diffusion or under normal gravitational forces. In some embodiments, the sampling devices can be used to sample liquid analyte including aqueous and non-aqueous samples. Selection of a particular sampling device for use can depend, at least in part, on the analytes to be collected and analyzed. Illustrative analytes include metals, non-metals, hydrocarbons, e.g., hydrocarbons with one or more carbon atoms, aromatics, and other organic and inorganic materials.

In certain embodiments, the sampling device may comprise a needle or a needle trap. One illustration is shown in FIG. 8, where a needle trap 800 comprises a needle 810 and a body 820. The body 820 may comprise one or more sorbent materials. The sorbent materials are effective to adsorb and desorb analytes. Illustrative sorbent materials include, but are not limited to, glass wool, polydimethylsiloxane coated particles, divinylbenzene, carbon black sorbent materials, graphited carbon black sorbent materials and combinations thereof or those sorbent materials described below in connection with sorbent tubes. The needle trap 800 may also comprise a ferrous coating (or magnetic coating) on some portion of the needle trap, or be produced from a ferrous material (or magnetic material), to trigger a magnetic sensor when the needle trap is inserted into an aperture of the sample introduction device.

In certain examples, a sorbent tube comprising one or more sorbent media can be used with the devices and systems described herein. Referring to FIG. 9, tube 900 comprises a body 910 which is typically a hollow body to permit packing of sorbent material within the hollow body. The body 910 of the tube 900 may comprise one or more metals, one or more glasses, one or more ceramics or combinations thereof. For example, the body 910 may comprise quartz, stainless steel, coated stainless steel, ferrous materials, magnetic materials or other metal or non-metal based materials that can tolerate the temperature cycles used to desorb the residue can be used. As discussed herein, it may be desirable to thermally couple the body 910 to a heat source for desorption of the adsorbed components. The body 910 may also comprise a ferrous coating (or magnetic coating) on some portion of the needle body 910, or be produced from a ferrous material or magnetic material), to trigger a magnetic sensor when the sorbent tube is inserted into an aperture of the sample introduction device. The tube 900 also comprises an inlet 920 and an outlet 925. Two different sorbent materials 930 and 940 are shown as being present within the body 910, though more than two sorbent materials are often present. The sorbent materials 930, 940 can be disposed within the hollow body 910 and occupy at least some portion of the internal volume of the body 910. In certain instances, the entire internal volume can be occupied by the different sorbent materials 930, 940, whereas in other examples, at least some portion of the internal volume can remain open, e.g., areas adjacent to the inlet 920 and the outlet 925 may be empty. The sorbent tube 900 can be fluidically coupled to an analytical device, e.g., a GC or GC/MS, using at least one magnetic coupler and a carrier gas can be swept through the sorbent tube 900 in the general direction from the outlet 925 to the inlet 920, typically accompanied by heating, to desorb the adsorbed residue species. In particular, the carrier gas may be provided in a direction which is generally a counter-flow or antiparallel flow to the direction of flow of the sample collection into the sorbent tube 900. The adsorbed species exit the sorbent tube 900 through the inlet 920. The desorbed species may then be provided to an injector and then to a chromatography column (not shown) to separate them, followed by subsequent analysis using a suitable analyzer or detector such as a flame ionization detector, mass spectrometer or other suitable detectors commonly found in or used with chromatography systems. If desired, the total amount of residue may be determined or the particular amount of one or more residue components can be determined, e.g., by using conventional standard curve techniques and standards. While not shown in FIG. 9, the tube 900 may comprise a selected amount of a material that is effective to provide a condensation surface without substantial adsorbance to the material. In some instances, this material can be positioned upstream of the sorbent material 930, e.g., closer to the inlet 920 than the sorbent material 930. In some instances, the bed length, e.g., length along the longitudinal axis of the sorbent tube 900, of the various materials used in the sorbent tube 900 may be the same, whereas in other instances the bed length can be different.

In certain embodiments, the sorbent tubes can include two, three, four, five or more sorbent materials. In some embodiments, two or more of the sorbent materials may be different, whereas in other embodiments two or more of the sorbent materials may be the same. The exact material used in the sorbent tubes can vary depending on the sampling conditions, desorption conditions, etc. In some examples, the sorbent tube can include a material comprising glass beads, glass wool, glass particles or combinations thereof or glass beads by themselves in combination with one or more other materials. While glass beads generally do not adsorb any of the materials, the glass beads can provide a high surface area to permit condensation of high molecular weight species, e.g., C22 and above, at the front end of the tube. The glass beads effectively remove the higher molecular weight species at the front end and permit the lower molecular weight species to travel down the tube and be adsorbed by one of the sorbent materials packed in the tube. In certain instances, two or more different types of glass beads can be present. In some embodiments, it may not be necessary to include a packed material to retain higher molecular weight components, e.g., C22 and above. As such, the sorbent tube may include internal surface features with high surface areas, e.g., integral glass beads, caps, chevrons, fins, glass beads etc. to retain the higher molecular weight components in the sorbent tube.

In some examples, one or more of the sorbent materials can be a graphitized carbon black such as, for example, Carbotrap™ B sorbent or Carbopack™ B sorbent, Carbotrap™ Z sorbent or Carbopack™ Z sorbent, Carbotrap™ C sorbent or Carbopack™ C sorbent, Carbotrap™ X sorbent or Carbopack™ X sorbent, Carbotrap™ Y sorbent or Carbopack™ Y sorbent, Carbotrap™ F sorbent or Carbopack™ F sorbent, any one or more of which may be used in its commercial form (available commercially from Supelco or Sigma-Aldrich) or may be graphitized according to known protocols. In other examples, the sorbent material can be carbon molecular sieves such as Carboxen™ 1000 sorbent, Carboxen™ 1003 sorbent, or Carboxen™-1016 sorbent, any one or more of which may be used in its commercial form (available commercially from Supelco or Sigma-Aldrich) or may be optimized according to known protocols.

In certain embodiments where three different materials are present, at least two of the materials may be one of the sorbent materials listed herein with each of the sorbent materials being a different sorbent material than the other sorbent materials used in the sorbent device. In such instances, two different sorbent materials would be present in the sorbent tube optionally with glass beads or other structure or material to provide an internal condensation surface. In some embodiments where three different sorbent materials are present, each of the sorbent materials may be one of the sorbent materials listed herein with each of the sorbent materials being a different sorbent material than the other sorbent materials used in the sorbent device. In such instances, three different sorbent materials would be present in the sorbent tube optionally with glass beads or other structure or material to provide an internal condensation surface. In some examples, the sorbent tubes described herein can include glass beads (or a material comprising glass beads) adjacent to the sorbent tube inlet and one or more materials other than glass beads downstream from the glass beads. For example, the sorbent tube may include glass beads and one or more Carbopack™ or Carbotrap™ materials. In some embodiments, the sorbent tube can include glass beads adjacent to the inlet and at least two different Carbopack™ materials downstream from the glass beads, e.g., closer to the outlet of the tube. In other embodiments, the sorbent tube can include glass beads adjacent to the inlet and at least two different Carbotrap™ materials downstream from the glass beads. In other embodiments, the sorbent tube can include glass beads adjacent to the inlet and at least one Carbotrap™ material downstream from the glass beads and at least one Carbopack™ material downstream from the glass beads. In packing the various materials, the material with the strongest adsorption strength is typically packed closest to the outlet and the sorbent with the weakest adsorption strength is packed closest to the inlet of the sorbent tube. As noted herein, the bed length of the various materials may be the same or may be different.

In certain examples, the mesh size or range of the materials in the sorbent tube can vary depending on the particular material selected. In some examples, the mesh size can range from 20 to about 100, more particularly from about 20-80, 30-70 or 40-60. In other examples, the mesh size range may be from about 20-40, 40-60, 60-80 or 80-100 depending on the material used in the sorbent tubes. Other suitable mesh sizes will be readily selected by the person of ordinary skill in the art, given the benefit of this disclosure.

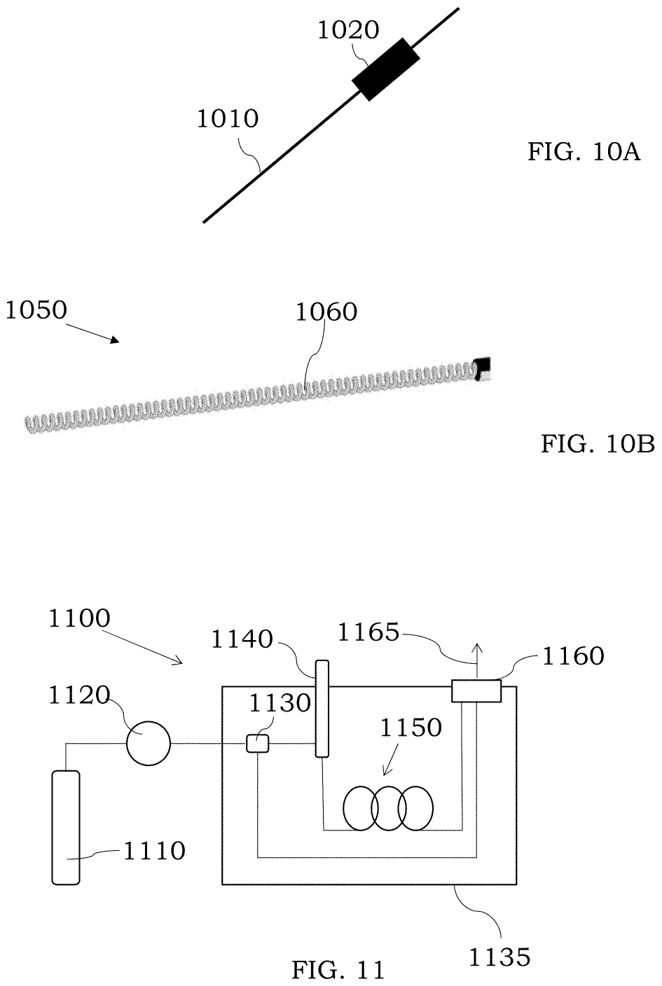

In certain embodiments, the sampling device may be configured to perform solid phase microextraction (SPME). In SPME, analyte is extracted, collected and concentrated. SPME techniques can use a SPME fiber that comprises one or more materials or material coatings that can adsorb or trap analytes. After trapping, the SPME fiber can be inserted directly into a heated injector port for thermal desorption, separation and detection. Illustrative materials that may be present on or in a SPME sampling device include, but are not limited to, divinylbenzene (DVB), polydimethysiloxane (PDMS), polyacrylates, carbon blacks, graphitized carbon blacks, carbon molecular sieves, Carboxen® materials, sorbent materials described in connection with the sorbent tubes and combinations thereof. The exact material present can depend, at least in part, on the nature of the analytes to be adsorbed. For example, PDMS is often used with non-polar analytes with molecular weights of 60-600 g/mol. Polyacrylate materials are often used to trap polar analytes with molecular weights of 80-300 g/mol. DVB/PDMS fibers are often used to trap aromatics having molecular weights of 50-500 g/mol. Carbon black/DPMS fibers are often used to trap highly volatile and semi-volatile analytes with molecular weights of 30-275 g/mol. Fibers with three or more different materials are also used in many instances where analytes of different volatilities are present in a sample. The SPME fibers may be present in a syringe, needle or other device as desired or may be present with a ferrule that can seal to the aperture on the sample introduction device. One illustration is shown in FIG. 10A, where a SPME fiber 1010 comprises a ferrule 1020 with a larger outer diameter than the fiber 1010. The fiber 1010, the ferrule 1020 or both may comprise a ferrous material that can be used to trigger a magnetic sensor once the fiber 1010 is inserted into a sample introduction device.

In some examples, a microextraction coil similar to the SPME fiber, but present in a coiled form, can be used to sample an environment and adsorb analytes to the coil. For example, a coiled material can be present in a syringe body and used to adsorb liquid analytes or gaseous analytes. Some portion of the microextraction coil may comprise a magnetic or ferrous material to trigger a magnetic sensor once the microextraction coil is inserted into a sample introduction device. Referring to FIG. 10B, a microextraction coil 1050 is shown that comprises a coiled body 1060 which can be present inside a syringe body or other housing. The coiled body 1060 may comprise, for example, one or more materials such as those described in connection with needle traps, SPME fibers and sorbent tubes. These materials may be coated onto the coiled body 1060, or the coiled body 1060 can be formed directly from these materials.

In certain embodiments, the sample introduction devices and sampling devices described herein are typically used with a chromatography system to separate the different analytes present in the sampling device. The chromatography system may be a gas chromatography system, a liquid chromatography system, a supercritical fluid chromatography system or other chromatography systems. The chromatography system can be portable, may be positioned on a bench in a laboratory or may take other forms. For example, the chromatography system can be sized similar to a briefcase or backpack so it can be transported into the field for measurements. In other instances, the chromatography system can take the form of a cartridge which may include suitable components on-board the cartridge for separation and/or detection.

In some embodiments and referring to FIG. 11, a simplified illustration of a gas chromatography system 1100 is shown, though other configurations of a GC system will be recognized by the person having ordinary skill in the art, given the benefit of this disclosure. The GC system 1100 comprises a carrier gas source 1110 fluidically coupled to a pressure regulator 1120 through a fluid line. The pressure regulator 1120 is fluidically coupled to a flow splitter 1130 through a fluid line. The flow splitter 1130 is configured to split the carrier gas flow into at least two fluid lines. The flow splitter 1130 is fluidically coupled to an injector 1140 through one of the fluid lines. A sample introduction device as described herein can be coupled to the injector 1140 to introduce sample from the sampling device into the injector 1140. For example, one or more magnetic couplers can hold the sampling device to the injector 1140 so sample can be provided into the injector 1140 from the sampling device. The introduced sample is vaporized in an oven 1135 that can house some portion of the injector 1140 and a column 1150 comprising a stationary phase. While not shown, the injector 1140 could be replaced entirely with a sorbent tube or device or SPME fiber configured to adsorb and desorb various analytes. The column 1150 separates the analyte species into individual analyte components and permits exit of those analyte species through an outlet 1160 in the general direction of arrow 1165. The exiting analyte can then be provided to one or more detectors as noted in more detail below. In some instances, a thermal desorption device or module (not shown) can be fluidically coupled to the injector 1140 and can be used to desorb analytes adsorbed to sorbent media in a sorbent tube or to desorb analytes adsorbed to an SPME fiber.

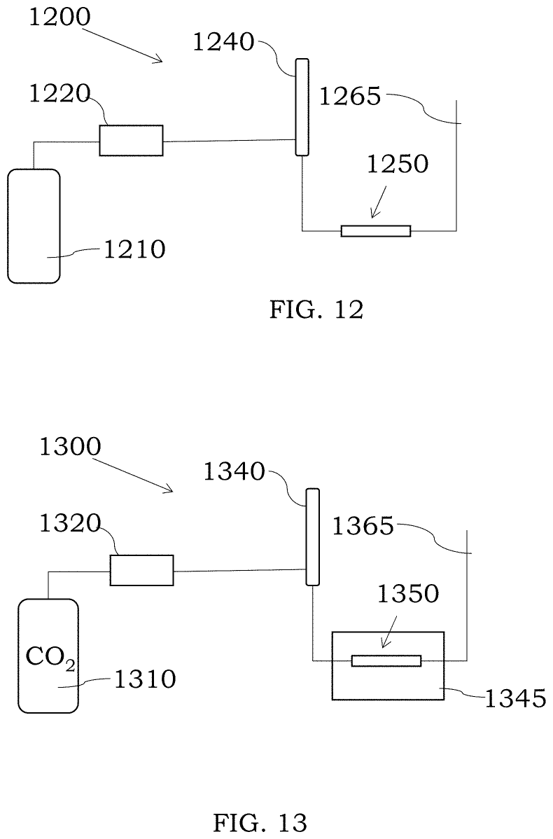

In certain embodiments, the sample introduction devices described herein can be used in a liquid chromatography system. In contrast to gas chromatography, liquid chromatography (LC) uses a liquid mobile phase and a stationary phase to separate species. Liquid chromatography may be desirable for use in separating various organic or biological analytes from each other. Referring to FIG. 12, a simplified schematic of one configuration of a liquid chromatography system is shown. In this configuration, the system 1200 is configured to perform high performance liquid chromatography. The system 1200 comprises a liquid reservoir(s) or source(s) 1210 fluidically coupled to one or more pumps such as pump 1220. The pump 1220 is fluidically coupled to an injector 1240 through a fluid line. If desired, filters, backpressure regulators, traps, drain valves, pulse dampers or other components may be present between the pump 1220 and the injector 1240. A sample can be introduced from a sample introduction device (as described herein) that is coupled to the injector 1240 using one or more magnetic couplers. A liquid sample is injected into the injector 1240 and provided to a column 1250. The column 1250 can separate the liquid analyte components in the sample into individual analyte components that elute from the column 1250. The individual analyte components can then exit the column 1250 through a fluid line 1265 and can be provided to one or detectors, analyzers or stages. Further, hybrid systems comprising serial or parallel GC/LC systems can also be used to vaporize certain analyte components and separate them using GC while permitting other components to be separated using LC techniques prior to providing the separated analyte components to one or more detectors or other components.

In some instances, other liquid chromatography techniques such as size exclusion liquid chromatography, ion-exchange chromatography, hydrophobic interaction chromatography, fast protein liquid chromatography, thin layer chromatography, immunoseparations or other chromatographic techniques can also be used. In certain embodiments, a supercritical fluid chromatography (SFC) system can be used. Referring to FIG. 13, the system 1300 comprises a carbon dioxide source 1310 fluidically coupled to one or more pumps such as pump 1320. The pump 1320 is fluidically coupled to an injector 1340 through a fluid line. If desired, filters, backpressure regulators, traps, drain valves, pulse dampers or other components may be present between the pump 1320 and the injector 1340. A liquid sample is injected into the injector 1340, e.g., from a sample introduction device as described herein, and provided to a column 1350 within an oven 1345. The column 1350 can use supercritical carbon dioxide to separate the liquid analyte components in the sample into individual analyte components that elute from the column 1350. The individual analyte components can then exit the column 1350 through a fluid line 1365 and can be provided to one or more detectors, analyzers or other components as described herein. Hybrid systems comprising serial or parallel GC/SFC systems can also be used to vaporize certain analyte components and separate them using GC while permitting other components to be separated using SFC techniques prior to providing the separated analyte components to one or more detectors or other components.

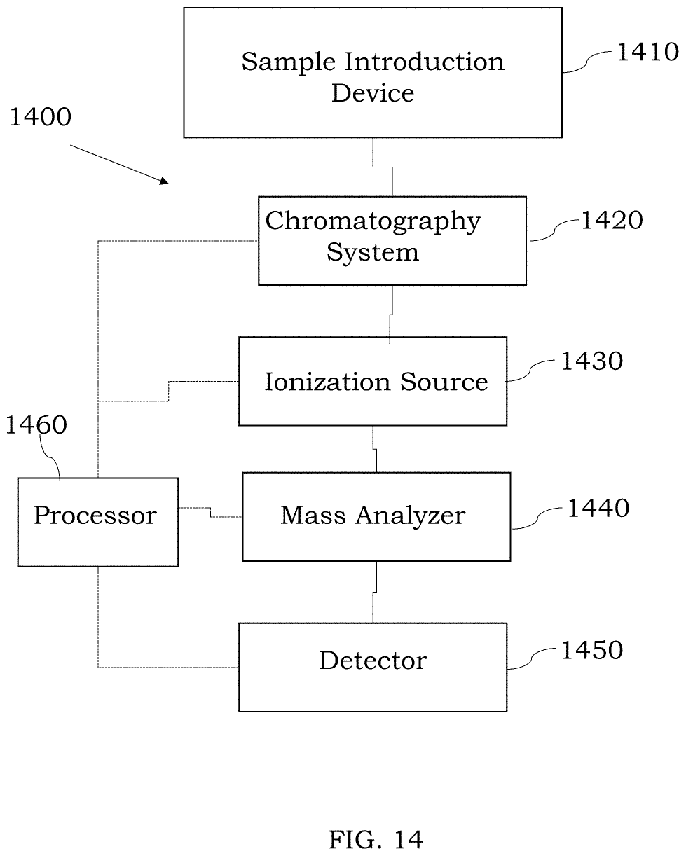

In certain embodiments, a sample introduction device and a chromatography system can be present or used with an instrument comprising an ionization source, a mass analyzer and a detector. A simplified illustration is shown in FIG. 14, where a system 1400 comprises a sample introduction device 1410, a chromatography system 1420, an ionization source 1430, a mass analyzer 1440 and a detector 1450. As sample is introduced from the sample introduction device 1410 and into the chromatography system 1420, individual analytes can elute from the chromatography system 1420 and be provided to an ionization source 1430. The ionization source 1430 can ionize the analyte and provide ionized analyte to the mass analyzer 1440 for filtering, selection or both. The resulting ions can be provided to a detector 1450 for detection.

In certain embodiments, the exact ionization source used may vary. For example, the ionization source 1430 comprises one or more of an inductively coupled plasma, a discharge plasma, a capacitively coupled plasma, a microwave induced plasma, a glow discharge ionization source, a desorption ionization source, an electrospray ionization source, an atmospheric pressure ionization source, atmospheric pressure chemical ionization source, a photoionization source, an electron ionization source, and a chemical ionization source. Other ionization sources and combinations of ionization sources may also be used.

In certain examples, the mass analyzer 1440 may comprise one or more rod assemblies such as, for example, a quadrupole or other rod assembly. The mass analyzer may further comprise one or more ion guides, collision cells, ion optics and other components that can be used to sample and/or filter an entering beam received from the ionization source 1430. The various components can be selected to remove interfering species, remove photons and otherwise assist in selecting desired ions from the entering ions. In some examples, the mass analyzer 1440 may be, or may include, a time of flight device. In some instances, the mass analyzer 1440 may comprise its own radio frequency generator. In certain examples, the mass analyzer 1440 can be a scanning mass analyzer, a magnetic sector analyzer (e.g., for use in single and double-focusing MS devices), a quadrupole mass analyzer, an ion trap analyzer (e.g., cyclotrons, quadrupole ions traps), time-of-flight analyzers (e.g., matrix-assisted laser desorbed ionization time of flight analyzers), and other suitable mass analyzers that can separate species with different mass-to-charge ratios. If desired, the mass analyzer 1440 may comprise two or more different devices arranged in series, e.g., tandem MS/MS devices or triple quadrupole devices, to select and/or identify the ions that are received from the ion interface. The mass analyzer can be fluidically coupled to a vacuum pump to provide a vacuum used to select the ions in the various stages of the mass analyzer. The vacuum pump is typically a roughing or foreline pump, a turbomolecular pump or both. Various components that can be present in a mass analyzer are described, for example, in commonly owned U.S. Pat. Nos. 10,032,617, 9,916,969, 9,613,788, 9,589,780, 9,368,334, 9,190,253 and other patents currently owned by PerkinElmer Health Sciences, Inc. (Waltham, Mass.) or PerkinElmer Health Sciences Canada, Inc. (Woodbridge, Canada).

In some embodiments, the mass analyzer 1440 may use an electric field, a magnetic field or both to filter or select ions. In one instance, mass analyzer may comprise an ion trap. While the exact components present in an ion trap may vary, a simple ion trap may comprise a central donut-shaped ring electrode and a pair of end cap electrodes. A variable radio-frequency (RF) voltage can be applied to the ring electrode while the two end cap electrodes are grounded. Ions with an appropriate mass-to-charge (m/z) ratio circulate in a stable orbit within the cavity surrounded by the ring electrode. As the RF voltage is increased, the orbits of heavier ions become stabilized, while those of lighter ions become destabilized causing them to collide with the wall of the ring electrode. By scanning the RF voltage after ions are introduced, destabilized ions exit the ring cavity through an opening in the end cap and they can be provided to a detector for detection. A cyclotron resonance trap could also be used with the sample introduction devices described herein if desired.

In some examples, the detector 1450 can be used to detect the ions filtered or selected by the mass analyzer. The detector may be, for example, any suitable detection device that may be used with existing mass spectrometers, e.g., electron multipliers, Faraday cups, coated photographic plates, scintillation detectors, multi-channel plates, etc., and other suitable devices that will be selected by the person of ordinary skill in the art, given the benefit of this disclosure. Illustrative detectors that can be used in a mass spectrometer are described, for example, in commonly owned U.S. Pat. Nos. 9,899,202, 9,384,954, 9,355,832, 9,269,552, and other patents currently owned by PerkinElmer Health Sciences, Inc. (Waltham, Mass.) or PerkinElmer Health Sciences Canada, Inc. (Woodbridge, Canada).

In certain instances, the system may also comprise a processor 1460, which typically take the forms of a microprocessor and/or computer and suitable software for analysis of samples introduced into the mass analyzer 1440. While the processor 1460 is shown as being electrically coupled to the chromatography system 1420, the ionization source 1430, the mass analyzer 1440 and the detector 1450, it can also be electrically coupled to the other components, e.g., to the sample introduction device, to generally control or operate the different components of the system. In addition, the processor 1460 can be electrically coupled to a magnetic sensor (or other sensor) that can be used to determine when the sampling device is present in a proper position to begin analysis. In some embodiments, the processor 1460 can be present, e.g., in a controller or as a stand-alone processor, to control and coordinate operation of the system for the various modes of operation using the system. For this purpose, the processor 1460 can be electrically coupled to each of the components of the system 1400, e.g., one or more pumps, one or more voltage sources, rods, etc.

In certain configurations, the processor 1460 may be present in one or more computer systems and/or common hardware circuitry including, for example, a microprocessor and/or suitable software for operating the system, e.g., to control the voltages of the ionization source, pumps, mass analyzer, detector, etc. In some examples, any one or more components of the system can include its own respective processor, operating system and other features to permit operation of that component. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Motorola PowerPC, Sun UltraSPARC, Hewlett-Packard PA-RISC processors, or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, calibrations and data during operation of the system in the various modes. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system 1400. For example, computer control can be implemented to control the vacuum pressure, to provide voltages to elements of the ion interface, etc. The processor 1460 typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface or the like or through one or more wireless interfaces, e.g., Bluetooth, Wi-Fi, Near Field Communication or other wireless protocols and/or interfaces.

In certain embodiments, the storage system used in the systems described herein typically includes a computer readable and writeable non-volatile recording medium in which codes can be stored that can be used by a program to be executed by the processor or information stored on or in the medium to be processed by the program. The medium may, for example, be a hard disk, solid state drive or flash memory. Typically, in operation, the processor causes data to be read from the non-volatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC) or a field programmable gate array (FPGA). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known Pentium class processors available from the Intel Corporation. Many other processors are also commercially available. Such a processor usually executes an operating system which may be, for example, the Windows 95, Windows 98, Windows NT, Windows 2000 (Windows ME), Windows XP, Windows Vista, Windows 7, Windows 8 or Windows 10 operating systems available from the Microsoft Corporation, MAC OS X, e.g., Snow Leopard, Lion, Mountain Lion or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

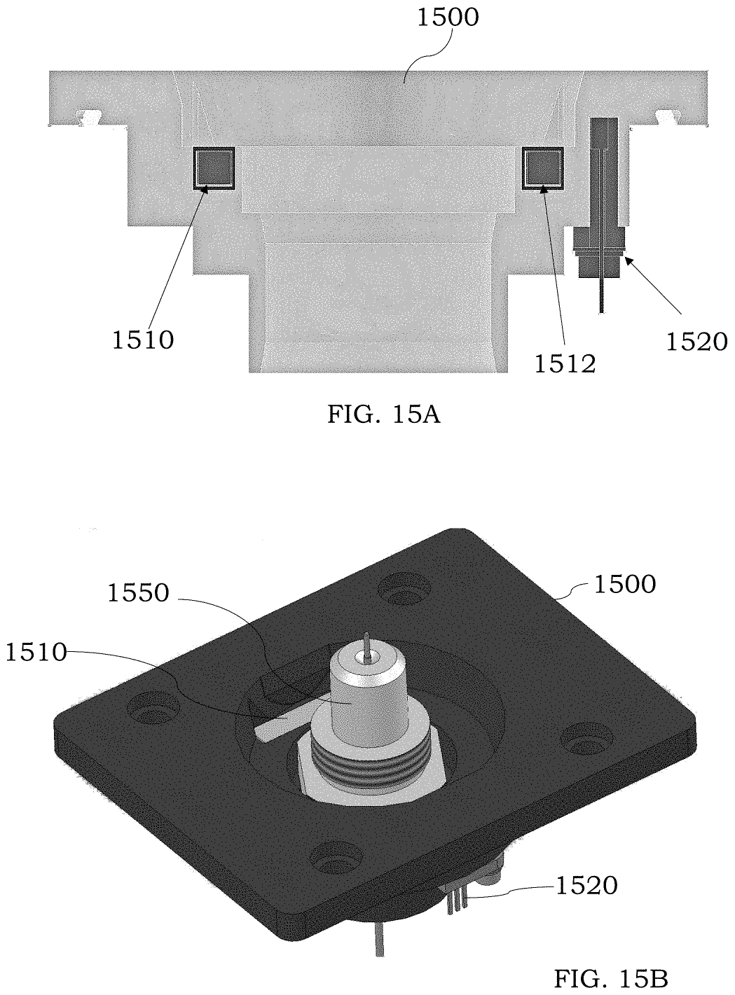

In certain examples and referring to FIG. 15A, the sample introduction device may comprise a body 1500 configured to receive a sampling device (not shown), a first magnetic coupler 1510, a second magnetic coupler 1512 and a magnetic sensor 1520. For example, each of the magnetic couplers 1510, 1512 can be configured as a Halbach array, and the magnetic sensor 1520 can be configured as a Hall effect sensor. Where the sampling device comprises a ferrous or magnetic material, insertion of the sampling device into the body 1500 can trigger the sensor 1520. Referring to FIG. 15B, a needle trap 1550 is shown as being placed in the body 1500. The magnetic couplers 1510, 1520 hold the needle trap 1550 in place and trigger the sensor 1520. Triggering of the sensor 1520 can be used by the processor (not shown) to initiate start of the instrument to receive and analyze the sample in the needle trap 1550.

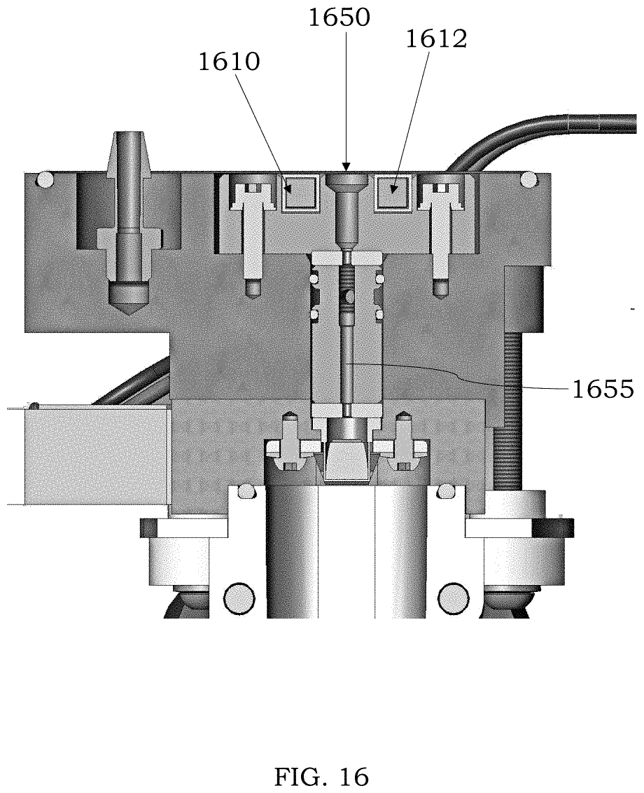

Referring to FIG. 16, a portion of an instrument is shown where a sample introduction device is coupled to the instrument. For example, a calibration sample can be placed onto a needle trap. The sample introduction device comprises first and second magnetic couplers 1610, 1612 and an aperture 1650 configured to receive the needle trap (not shown). The tip of the needle is inserted onto the large area (below element 1655) and a portioned amount of gas fills the chamber. This coupling pressurizes the chamber, and the gas is forced through the needle trap. The bed inside the needle trap captures the calibrated standard and the carrier gas exits the instrument.

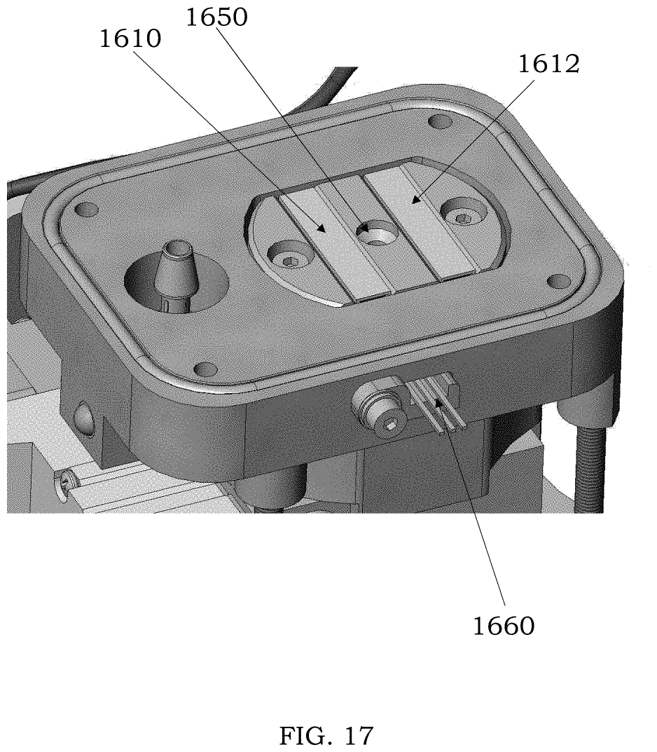

Referring to FIG. 17, which shows a different view of the components of FIG. 16, another view of magnetic couplers and a magnetic sensor are shown. The first magnetic coupler 1610 and the second magnetic coupler 1612 are positioned adjacent to an aperture 1650 configured to receive a sampling device. A magnetic sensor 1660, e.g., a Hall effect sensor, is configured to determine when the sampling device is inserted into the aperture 1650. Activation of the magnetic sensor 1660 can send a signal to a processor to initiate analysis of the sample or otherwise initiate the processor to perform some other step. The exact length and dimensions of the aperture 1650 may vary. In some configurations, the aperture 1650 can be sized and arranged to receive a sampling device and retain it through a friction fit between the aperture 1650 and by using a magnetic field provided by the magnetic couplers 1610, 1612. As noted herein, gaskets, seals or other fittings and couplings can also be used if desired. For example, the aperture may be configured to permit insertion of some portion of the sampling device into the aperture 1650 while engaging a larger portion of the sampling device, e.g., engaging a ferrule, syringe barrel, etc., at an upper surface to prevent over insertion of the sampling device.

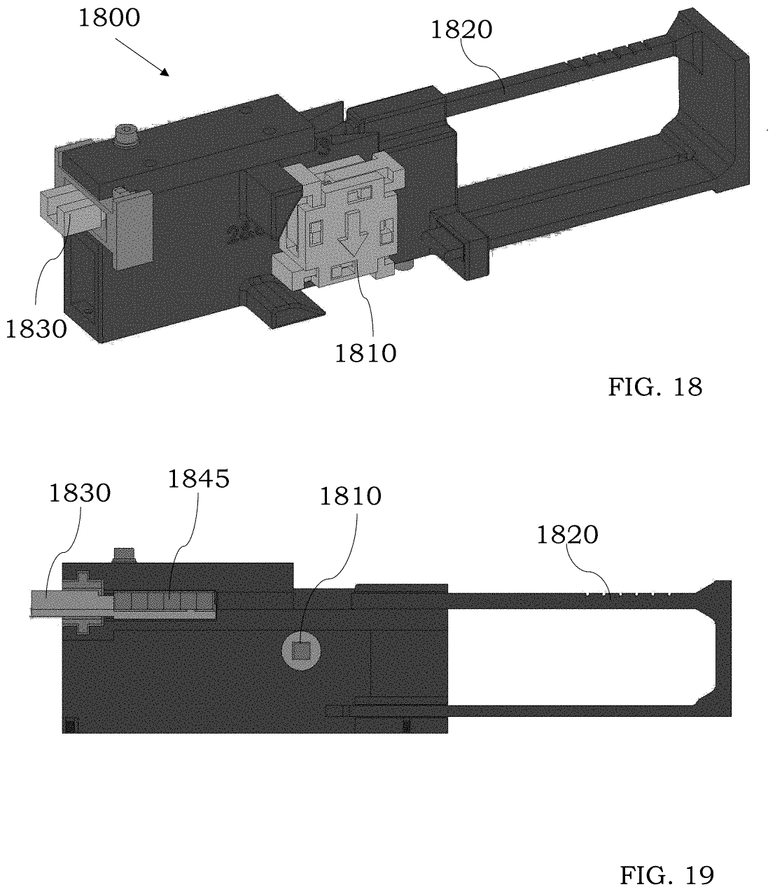

In certain configurations, an assembly fixture can be used to assemble magnetic couplers which can be used in the sample introduction devices described herein and in other devices that may use a magnetic coupler with different magnetic field strengths at different surfaces. For example, the assembly fixture can be used to provide a magnetic coupler comprising a plurality of arranged, individual permanent magnets. The assembly fixture can successively receive and insert individual permanent magnets into a housing of the magnetic coupler. Referring to FIG. 18, an assembly fixture 1800 is shown that comprises a magnet rotator assembly 1810 configured to arrange and offset pole orientations of the successively inserted individual magnets by ninety degrees prior to insertion of the successively inserted individual magnets into the housing of the magnetic coupler. The assembly fixture 1800 also comprises an insertion device, e.g., a plunger 1820, that can be used to insert the magnets into the housing of the magnetic coupler, and a magnetic coupler housing holder 1830 that can receive the housing of the magnetic coupler. Referring to FIG. 19, magnets 1845 can be positioned and placed adjacent to the holder 1830. The magnet rotator assembly 1810 in combination with movement of the plunger 1820 can position the magnets in a proper orientation and insert them into an open end of the housing of the magnetic coupler.

In one illustration, the rotator assembly 1810 comprises an arrow, which is pointing downward in FIG. 18. A housing of the magnetic coupler is inserted into the fixture 1800 at the holder 1830. Magnets can be loaded into the fixture 1800 above the rotator assembly 1810. When the plunger 1820 is pushed in toward the holder 1830, a magnet is inserted into the housing and the rotator assembly 1810 rotates 90 degrees so the arrow is now pointing to the left side of the fixture 1800. This rotation of the rotator assembly 1810 also rotates the next magnet to be inserted into the housing by 90 degrees. After extraction of the plunger 1820, the plunger can be depressed to insert the next magnet into the coupler housing in an orientation that is offset by 90 degrees from the prior inserted magnet. Insertion of a second magnet also rotates the rotator assembly 1810 again by 90 degrees. This process can be repeated until a desired number of magnets is inserted into the housing to provide a magnetic coupler. For example, the rotator assembly 1810 may comprise four different positions that can be used to position the magnets properly prior to insertion into a housing of the magnetic coupler. The rotator assembly 1810 can include a magnet loading station configured to receive an individual permanent magnet, wherein a first position, a second position, a third position and a fourth position of the magnet rotator assembly orient poles of the individual magnets in different pole orientations to provide a Halbach array. The holder 1830 may comprise a slot configured to receive the housing of the magnetic coupler. Alternatively, the holder 1830 may be sized and arranged, to receive an insert that retains the housing of the magnetic coupler in the assembly fixture 1800. The holder 1830 can be sized and arranged to receive housing of different lengths. If desired, a first holder 1830 can be removed and replaced with a longer holder that can receive a magnetic coupler housing. For example, a holder 1830 can be used to load four permanent magnets into a housing a first magnetic coupler. The holder 1830 can be replaced with a longer holder used to load six permanent magnets into a housing a second magnetic coupler. The holder 1830 need not be rectangular but could instead be shaped differently to receive a housing having a non-rectangular shape.

In certain embodiments, pushing in of the insertion device 1820 can engage the rotator assembly 1810 and cause it to rotate to its next position. Alternatively, retraction of the insertion device 1820 after placement of a loaded, individual magnet into the housing of the magnetic coupler can contact the magnet rotator assembly 1810 to rotate the magnet rotator assembly 1810 to a different position. In another configuration, an end user can manually rotate the rotator assembly 1810 to its next position.

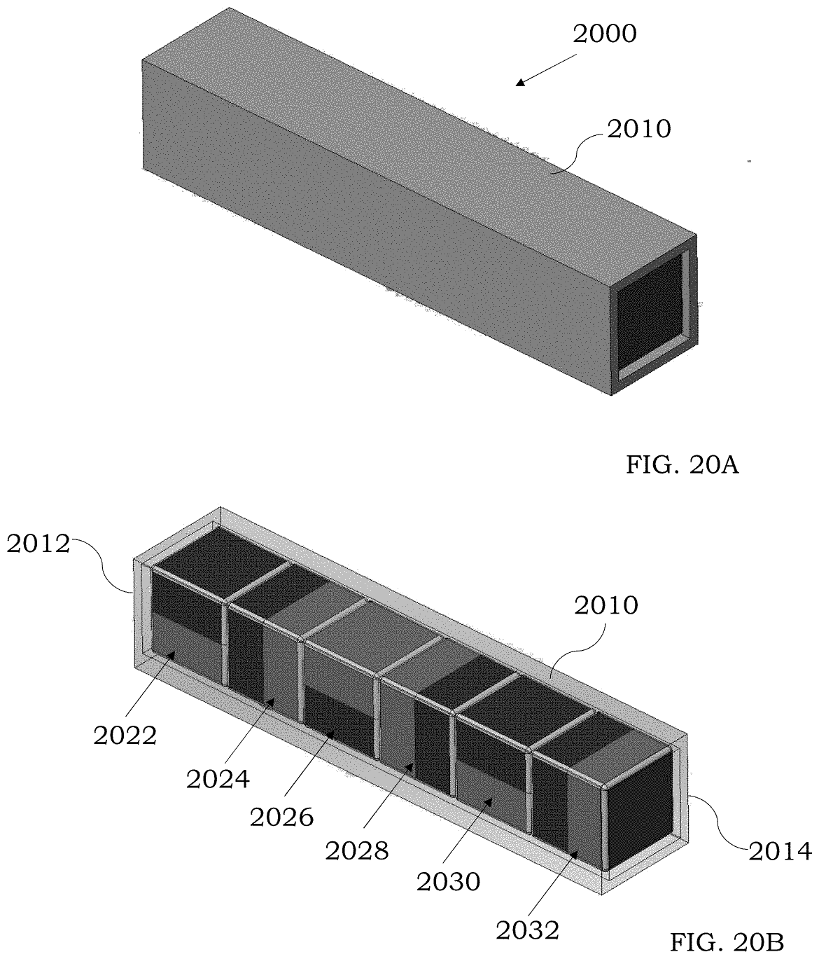

In certain configurations and referring to FIGS. 20A and 20B, a magnetic coupler 2000 is shown comprising a housing 2010 and a plurality of inserted permanent magnets 2022, 2024, 2026, 2028, 2030 and 2032 in the housing. Starting from a first end 2012 of the coupler 2000 and moving toward a second end 2014 of the coupler 2000, the first magnet 2022 comprises a north pole facing upward and a south pole facing downward. Reference to north and south poles is made solely for convenience purposes and is not intended to imply any orientation is required for the first magnet 2022. The second magnet 2024 has its north pole facing toward the left and its south pole facing toward the right. The third magnet 2026 has its north pole facing downward and its south pole facing upward. The fourth magnet 2028 has its north pole facing to the right and its south pole facing to the left. The fifth magnet 2030 has its north pole facing upward and its south pole facing downward. The sixth magnet 2032 has its north pole facing to the left and its south pole facing to the right. In certain configurations, a magnetic field at one surface or side of the coupler 2000 may have a magnetic field strength larger than a magnetic field strength at a different surface. For example, the magnetic coupler 2000 can be configured as a Halbach array where a magnetic field on one side of the coupler 2000 is larger than a magnetic field on a second surface or side of the coupler 2000. In some instances, the magnetic field at one surface may be zero or close to zero. In certain configurations, the magnetic field strength at a first surface of the magnetic coupler can vary from about −100 Gauss to about 200 Gauss, e.g., about −70 Gauss to about 180 Gauss. The magnetic field strength at a second surface cay vary from about 400 Gauss to about 700 Gauss, e.g., about 400 Gauss to about 670 Gauss. The magnets used in the magnetic coupler 2000 can be rare earth magnets, neodymium iron boron (NdFeB) magnets, samarium cobalt (SmCo) magnets, aluminum nickel cobalt (alnico) magnets, ceramic magnets, ferrite magnets or combinations thereof.

While linear arrays of magnets are produced using the fixture 1800, the magnetic couplers described herein may include shapes other than linear shapes. For example, circular Halbach arrays may be used or present in a magnetic coupler used to hold down a sampling device. Alternatively, combinations of differently shaped Halbach arrays can be present if desired.

In certain embodiments, to retain the magnets in the housing of the magnetic coupler, the ends of the housing 2010 can be sealed, e.g., with a plate or other structure. In other instances, tape, adhesive, sealant or other materials may be placed at the ends 2012, 2014 to retain the magnets in the housing 2010. In some instances, the ends 2012, 2014 can be crimped to retain the magnets in the housing 2010. The housing 2010 typically comprises a non-magnetic or non-ferrous material and may be produced from metals, plastics, polymers, papers or other materials.

In certain embodiments, an assembly fixture to provide a magnetic coupler may comprise a magnet loading station, a magnet rotator assembly, a first end configured to receive a housing of a magnetic coupler and an insertion device. The magnet loading station can be sized and arranged to receive an individual permanent magnet. The magnet rotator assembly can be magnetically coupled to the magnet loading station and may include a first position, a second position, a third position and a fourth position. The first end of the fixture can receive a housing which is configured to successively receive a plurality of individually arranged permanent magnets and retain the received, plurality of individually arranged permanent magnets in the housing of the magnetic coupler. The insertion device can be configured to provide a force to insert an individual permanent magnet in the magnet loading station into the housing of the magnetic coupler. In some instances, the first position of the magnet rotator assembly permits loading of a first individual permanent magnet into the magnet loading station at a first pole orientation. Insertion of the loaded, first individual permanent magnet, using the insertion device, into the housing of the magnetic coupler rotates the magnet rotator assembly from the first position to the second position. The second position of the magnet rotator assembly permits loading of a second individual permanent magnet into the magnet loading station at a second pole orientation rotated ninety degrees from the first pole orientation. Insertion of the loaded, second individual permanent magnet, using the insertion device, into the housing of the magnetic coupler rotates the magnet rotator assembly from the second position to the third position. The third position of the magnet rotator assembly permits loading of a third individual permanent magnet into the magnet loading station at a third pole orientation rotated ninety degrees from the second pole orientation. Insertion of the loaded, third individual permanent magnet, using the insertion device, into the housing of the magnetic coupler rotates the magnet rotator assembly from the third position to the fourth position. The fourth position of the magnet rotator assembly permits loading of a fourth individual permanent magnet into the magnet loading station at a fourth pole orientation rotated ninety degrees from the third pole orientation, Insertion of the loaded, fourth individual permanent magnet, using the insertion device, into the housing of the magnetic coupler rotates the magnet rotator assembly from the fourth position to the first position and produces or provides a magnetic coupler comprising a first surface and a second surface opposite the first surface, wherein the magnetic coupler comprises a first magnetic field at the first surface, and wherein a magnitude of a second magnetic field at the second surface of the magnetic coupler is less than a magnitude of the first magnetic field. In certain configurations, after insertion of the fourth individual permanent magnet, the magnet rotator assembly moves back to the first position, which permits loading of a fifth individual permanent magnet into the magnet loading station. Insertion of the loaded, fifth individual permanent magnet into the housing of the magnetic coupler aligns a pole orientation of the inserted fifth individual permanent magnet with the first pole orientation. After insertion of the fifth individual permanent magnet, the second position permits loading of a sixth individual permanent magnet into the magnet loading station, wherein insertion of the loaded, sixth individual permanent magnet into the housing of the magnetic coupler aligns a pole orientation of the inserted sixth individual permanent magnet with the second pole orientation. This process can be repeated until a desired number of magnets are inserted into a housing of a magnetic coupler.

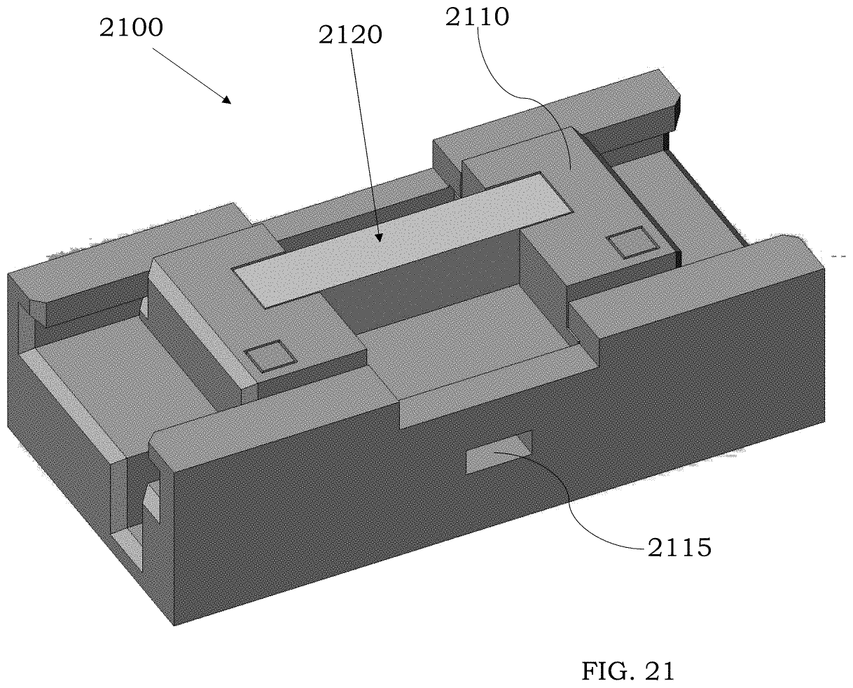

In some examples, a test fixture 2100 (see FIG. 21) can be used to test or measure the magnetic field strength at different surfaces or ends of a magnetic coupler. The test fixture 2100 can include a slidable tray 2110 that can receive a magnetic coupler 2120. A slot 2115 can receive a probe to measure the magnetic field strength. The tray 2110 can be moved from side to side to measure the magnetic field strength at different surfaces or ends of the coupler 2120. The exact shape and size of the tray 2110 can vary and desirably the tray includes a slot that can hold the coupler in place while magnetic field strength measurements are performed.

In certain embodiments, the assembly fixture and test fixture can be packaged into a kit with printed or electronic instructions of how to use the assembly fixture to produce a magnetic coupler and/or how to use the text fixture to measure magnetic field strength at different surfaces of the magnetic coupler. In some embodiments, the kit may also comprise a magnetic coupler housing, permanent magnets and other components as desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1-45. (canceled)

46. An assembly fixture to provide a magnetic coupler comprising a plurality of arranged, individual permanent magnets, the assembly fixture configured to successively receive and insert individual permanent magnets into a housing of the magnetic coupler, wherein the assembly fixture comprises a magnet rotator assembly configured to arrange and offset pole orientations of the successively inserted individual magnets by ninety degrees prior to insertion of the successively inserted individual magnets into the housing of the magnetic coupler, and wherein the plurality of inserted, arranged, individual permanent magnets together function as the magnetic coupler, wherein the magnetic coupler comprises a first surface and a second surface opposite the first surface, wherein the magnetic coupler comprises a first magnetic field at the first surface, and wherein a magnitude of a second magnetic field at the second surface of the magnetic coupler is less than a magnitude of the first magnetic field.

47. The assembly fixture of claim 46, wherein the magnet rotator assembly comprises a first position, a second position, a third position and a fourth position.

48. The assembly fixture of claim 46, further comprising a slot configured to receive the housing of the magnetic coupler.

49. The assembly fixture of claim 48, wherein the slot is sized and arranged to receive an insert that retains the housing of the magnetic coupler in the assembly fixture.

50. The assembly fixture of claim 47, wherein the magnet rotator assembly comprises a magnet loading station configured to receive an individual permanent magnet, wherein the first position, the second position, the third position and the fourth position of the magnet rotator assembly orient poles of the individual magnets in different pole orientations.

51. The assembly fixture of claim 50, further comprising an insertion device configured to engage a loaded, individual magnet in the magnetic loading station and provide a force to place the loaded, individual magnet into the housing of the magnetic coupler.

52. The assembly fixture of claim 51, wherein depression of the insertion device to place the loaded, individual magnet into the housing of the magnetic coupler contacts the magnet rotator assembly to rotate the magnet rotator assembly to a different position.

53. The assembly fixture of claim 51, wherein retraction of the insertion device after placement of the loaded, individual magnet into the housing of the magnetic coupler contacts the magnet rotator assembly to rotate the magnet rotator assembly to a different position.

54. The assembly fixture of claim 48, wherein the slot is sized and arranged to receive the housing, and wherein the housing is sized and arranged to receive at least four individual permanent magnets.

55. The assembly fixture of claim 48, wherein the slot is sized and arranged to receive the housing, and wherein the housing is sized and arranged to receive at least six individual permanent magnets.

56. An assembly fixture to provide a magnetic coupler comprising:
a magnet loading station sized and arranged to receive an individual permanent magnet;
a magnet rotator assembly magnetically coupled to the magnet loading station, wherein the magnet rotator assembly comprises a first position, a second position, a third position and a fourth position;
a first end configured to receive and position a housing of the magnetic coupler, wherein the housing of the magnetic coupler is configured to successively receive a plurality of individually arranged permanent magnets and retain the received, plurality of individually arranged permanent magnets in the housing of the magnetic coupler;
an insertion device configured to provide a force to insert an individual permanent magnet in the magnet loading station into the housing of the magnetic coupler,
wherein the first position of the magnet rotator assembly permits loading of a first individual permanent magnet into the magnet loading station at a first pole orientation,
wherein insertion of the loaded, first individual permanent magnet, using the insertion device, into the housing of the magnetic coupler rotates the magnet rotator assembly from the first position to the second position,
wherein the second position of the magnet rotator assembly permits loading of a second individual permanent magnet into the magnet loading station at a second pole orientation rotated ninety degrees from the first pole orientation,
wherein insertion of the loaded, second individual permanent magnet, using the insertion device, into the housing of the magnetic coupler rotates the magnet rotator assembly from the second position to the third position,
wherein the third position of the magnet rotator assembly permits loading of a third individual permanent magnet into the magnet loading station at a third pole orientation rotated ninety degrees from the second pole orientation,
wherein insertion of the loaded, third individual permanent magnet, using the insertion device, into the housing of the magnetic coupler rotates the magnet rotator assembly from the third position to the fourth position,
wherein the fourth position of the magnet rotator assembly permits loading of a fourth individual permanent magnet into the magnet loading station at a fourth pole orientation rotated ninety degrees from the third pole orientation,
wherein insertion of the loaded, fourth individual permanent magnet, using the insertion device, into the housing of the magnetic coupler rotates the magnet rotator assembly from the fourth position to the first position and provides a magnetic coupler comprising a first surface and a second surface opposite the first surface, wherein the magnetic coupler comprises a first magnetic field at the first surface, and wherein a magnitude of a second magnetic field at the second surface of the magnetic coupler is less than a magnitude of the first magnetic field.

57. The assembly fixture of claim 56, wherein, after insertion of the fourth individual permanent magnet, the first position permits loading of a fifth individual permanent magnet into the magnet loading station, wherein insertion of the loaded, fifth individual permanent magnet into the housing of the magnetic coupler aligns a pole orientation of the inserted fifth individual permanent magnet with the first pole orientation.

58. The assembly fixture of claim 57, wherein, after insertion of the fifth individual permanent magnet, the second position permits loading of a sixth individual permanent magnet into the magnet loading station, wherein insertion of the loaded, sixth individual permanent magnet into the housing of the magnetic coupler aligns a pole orientation of the inserted sixth individual permanent magnet with the second pole orientation.

59. The assembly fixture of claim 56, wherein the first end comprises a slot sized and arranged to receive the housing of the magnetic coupler.

60. (canceled)

61. A method of producing a magnetic coupler comprises successively placing a plurality of individual permanent magnets into a housing of the magnetic coupler by:
loading a first individual permanent magnet into a magnet loading station at a first position of a magnet rotator assembly;
installing the loaded, first individual permanent magnet into the housing, wherein installing the loaded first individual permanent magnet into the housing rotates the magnet rotator assembly to a second position;
loading a second individual permanent magnet into the magnet loading station at the second position of the magnet rotator assembly, wherein the second position loads the second individual permanent magnet into the magnet loading station so a pole orientation of the loaded, second individual permanent magnet is ninety degrees from a pole orientation of the loaded, first individual permanent magnet;
installing the loaded, second individual permanent magnet into the housing, wherein installing the loaded second individual permanent magnet into the housing rotates the magnet rotator assembly to a third position;
loading a third individual permanent magnet into the magnet loading station at the third position of the magnet rotator assembly, wherein the third position loads the third individual permanent magnet into the magnet loading station so a pole orientation of the loaded, third individual permanent magnet is ninety degrees from a pole orientation of the loaded, second individual permanent magnet;
installing the loaded, third individual permanent magnet into the housing, wherein installing the loaded, third individual permanent magnet into the housing rotates the magnet rotator assembly to a fourth position;
loading a fourth individual permanent magnet into the magnet loading station at the fourth position of the magnet rotator assembly, wherein the fourth position loads the fourth individual permanent magnet into the magnet loading station so a pole orientation of the loaded, fourth individual permanent magnet is ninety degrees from a pole orientation of the loaded, third individual permanent magnet; and
installing the loaded, fourth individual permanent magnet into the housing, wherein installing the loaded, fourth individual permanent magnet into the housing rotates the magnet rotator assembly to the first position, and wherein the produced magnetic coupler comprises a first magnetic field at a first surface of the housing and substantially no magnetic field at a second, opposite surface of the housing.

62. The method of claim 61, further comprising, after installing the loaded, fourth individual permanent magnet,
loading a fifth individual permanent magnet into the magnet loading station at the first position of the magnet rotator assembly, wherein the first position loads the fifth individual permanent magnet into the magnet loading station so a pole orientation of the loaded, fifth individual permanent magnet is ninety degrees from a pole orientation of the loaded, fourth individual permanent magnet, and
installing the loaded, fifth individual permanent magnet into the housing, wherein installing the loaded, fifth individual permanent magnet into the housing rotates the magnet rotator assembly to the second position.

63. The method of claim 62, further comprising, after installing the loaded, fifth individual permanent magnet,
loading a sixth individual permanent magnet into the magnet loading station at the second position of the magnet rotator assembly, wherein the second position loads the sixth individual permanent magnet into the magnet loading station so a pole orientation of the loaded, sixth individual permanent magnet is ninety degrees from a pole orientation of the loaded, fifth individual magnet, and
installing the loaded, sixth individual permanent magnet into the housing, wherein installing the loaded, sixth individual permanent magnet into the housing rotates the magnet rotator assembly to the third position.

64. The method of claim 61, further comprising sealing ends of the housing to retain the installed, individual first, second, third and fourth permanent magnets in the housing.

65. The method of claim 61, further comprising crimping ends of the housing to retain the installed, individual first, second, third and fourth permanent magnets in the housing.

66. The method of claim 61, further comprising applying an adhesive to at least one end of the housing to retain the installed, individual first, second, third and fourth permanent magnets in the housing.

67-68. (canceled)
